(19) United States
(12) Patent Application Publication
(10) Pub. No.: US 2025/0087734 A1
(43) Pub. Date: Mar. 13, 2025

(54) THERMALLY-COUPLED METAL HYDRIDE ENERGY SYSTEMS AND METHODS

(71) Applicant: Lumindt Labs, Inc., San Francisco, CA (US)

(72) Inventors: Miriam Rath, Redwood City, CA (US); Bruno Geoly, Redwood City, CA (US); Amir Ahdnoparvin, San Francisco, CA (US)

(73) Assignee: Lumindt Labs, Inc., San Francisco, CA (US)

(21) Appl. No.: 18/829,243

(22) Filed: Sep. 9, 2024

Related U.S. Application Data
(60) Provisional application No. 63/581,601, filed on Sep. 8, 2023.
(60) Provisional application No. 63/581,626, filed on Sep. 8, 2023.
(60) Provisional application No. 63/581,206, filed on Sep. 7, 2023.
(60) Provisional application No. 63/581,338, filed on Sep. 8, 2023.
(60) Provisional application No. 63/551,501, filed on Feb. 8, 2024.
(60) Provisional application No. 63/554,889, filed on Feb. 16, 2024.

(51) Int. Cl. H01M 8/065; C01B 3/00; C25B 1/04; C25B 15/021; C25B 15/027; H01M 8/0432; H01M 8/0438; H01M 8/0656

(52) U.S. Cl. CPC H01M 8/065; C01B 3/0036; C25B 1/04; C25B 15/021; C25B 15/027; H01M 8/04373; H01M 8/04425; H01M 8/0656

(57) ABSTRACT

One embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; and a computing system operatively coupled to the electrolysis module, storage module, and fuel cell module and configured to coordinate operation of these modules relative to each other; wherein the electrolysis, storage, and fuel cell modules are thermally coupled such that heat energy released from one or more modules which may be at least transiently exothermic may be utilized by one or modules which may be at least transiently endothermic.

### RELATED APPLICATIONS

The present application claims the benefit of priority to U.S. Provisional Patent Application Ser. No. 63/581,601 titled “HYDRONIC THERMALLY COUPLED METAL HYDRIDE AND PROTON EXCHANGE MEMBRANE ELECTROLYZER SYSTEM”, filed on Sep. 8, 2023, and to U.S. Provisional Patent Application Ser. No. 63/581,626 titled “THERMALLY COUPLED FULL POWER-TO-POWER ELECTROLYZER-METAL HYDRIDE-FUEL CELL HYDRONIC THERMAL MANAGEMENT SYSTEM”, filed on Sep. 8, 2023, and to U.S. Provisional Patent Application Ser. No. 63/581,206 titled “METAL HYDRIDE VESSEL DESIGN FOR A HYDRONIC THERMAL MANAGEMENT SYSTEM”, filed on Sep. 7, 2023, and to U.S. Provisional Patent Application Ser. No. 63/581,338 titled “A HYDRONIC THERMALLY COUPLED METAL HYDRIDE AND PROTON EXCHANGE MEMBRANE FUEL CELL SYSTEM”, filed on Sep. 8, 2023, and to U.S. Provisional Patent Application Ser. No. 63/551,501 titled “THERMALLY-COUPLED METAL HYDRIDE ENERGY SYSTEMS AND METHODS”, filed on Feb. 8, 2024, and to U.S. Provisional Patent Application Ser. No. 63/554,889 titled “THERMALLY-COUPLED METAL HYDRIDE ENERGY SYSTEMS AND METHODS”, filed on Feb. 16, 2024, all of which are hereby incorporated by reference in their entirety.

### FIELD OF THE INVENTION

The present invention relates generally to systems and methods for providing flexible and efficient energy solutions utilizing metal hydride storage configurations, and in particular to systems and methods configured to gain efficiencies through thermal coupling of various functional elements.

### BACKGROUND

Metal hydride systems have evolved in various applications for safely storing and supplying hydrogen to operational energy system elements such as fuel cells. Further, electrolyzer technologies have continued to advance as clean and efficient means for converting electricity to hydrogen, for storage and/or operational consumption. Indeed, metal hydride and electrolysis systems have seen significant development over the years, and there has been exploration in using these technologies together in tandem, such as in configurations wherein green hydrogen is produced using an electrolyzer and then stored in a metal hydride storage vessel for future use. So-called “proton exchange membrane” (PEM) electrolyzer configurations have been considered as attractive system elements given their relatively high efficiency, fast start-up and shutdown times, compact and lightweight design, and relatively high purity hydrogen gas output. As with most power or energy systems, there remains active interest in potential efficiency gains.

It is known that metal hydride systems undergo an exothermic reaction during hydrogen absorption and an endothermic reaction during hydrogen desorption. Indeed, these chemical reactions can generate significant amounts of heat loss or gain, leading to temperature fluctuations and potential thermal instability within a given system configuration, and it is generally believed that thermal management is critical for safe operation of metal hydride systems. Similarly, waste heat generation in electrolyzers is a natural byproduct of the electrochemical process wherein water is split into oxygen and hydrogen gas. The electrochemical reactions at the anode and the cathode of a PEM electrolyzer, for example, are not 100% efficient. Some of the energy from the electrical input is converted into heat instead of being used to split water molecules. Thus, produced (or so-called “waste”) heat needs to be managed to ensure efficiency and safe operation as excessive heat can lead to reduced electrolysis efficiency, damage to the proton exchange membrane and electrode catalysts, and safety concerns regarding the potential for the release of flammable hydrogen gas.

Conventional thermal management techniques pertaining to metal hydride systems typically involve external heat exchangers, such as shell-and-tube design, external fins, or passive thermal management techniques such as phase change materials, and external thermal insulation. In other words, the produced heat is typically intentionally distributed away or wasted. Other thermal management systems used for metal hydride systems include liquid-based coolant systems that are integrated either outside or inside the metal hydride vessels to provide heat or move heat during the metal hydride reactions. For PEM electrolyzers, cooling systems also may be utilized to maintain an electrolyzer element within an optimal range of hydrogen production rate and energy consumption rate. With such configurations and PEM style electrolyzers, two main types of cooling systems generally are used: liquid cooling, and air cooling. With liquid cooling configurations, a coolant may be configured to circulate through channels or heat exchangers within the electrolyzer stacks. As the coolant flows, it may absorb heat from the stack components and remove it from the system, assisting in the system generally to maintain consistent temperatures and prevent overheating. With air cooling configurations, fans may be utilized to direct ambient air over an electrolyzer stack to dissipate heat. While air cooling is simpler and requires fewer components than liquid cooling, it may not be as efficient at managing heat. There is a need for system configurations and associated methods to facilitate enhanced overall efficiency gains through the use of thermal coupling of various elements, and generally to the preservation and utilization of thermal energy within a hydrogen-based energy system. Described herein are various embodiments pertaining to a hydronic thermal management systems and methods designed to thermally couple the metal hydride vessel elements with other elements such as electrolyzer elements, fuel cell elements, and other elements often present in the modern environment.

### BRIEF DESCRIPTION

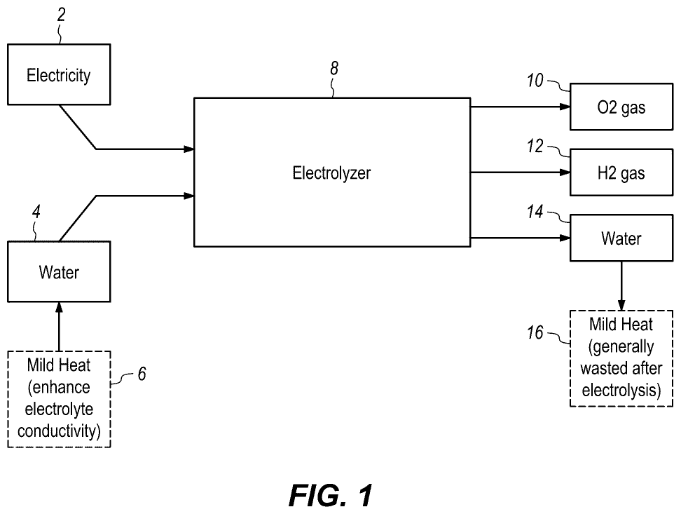

FIGS. 1-3 illustrate various aspects of electrolyzer, storage vessel, and fuel cell process flows.

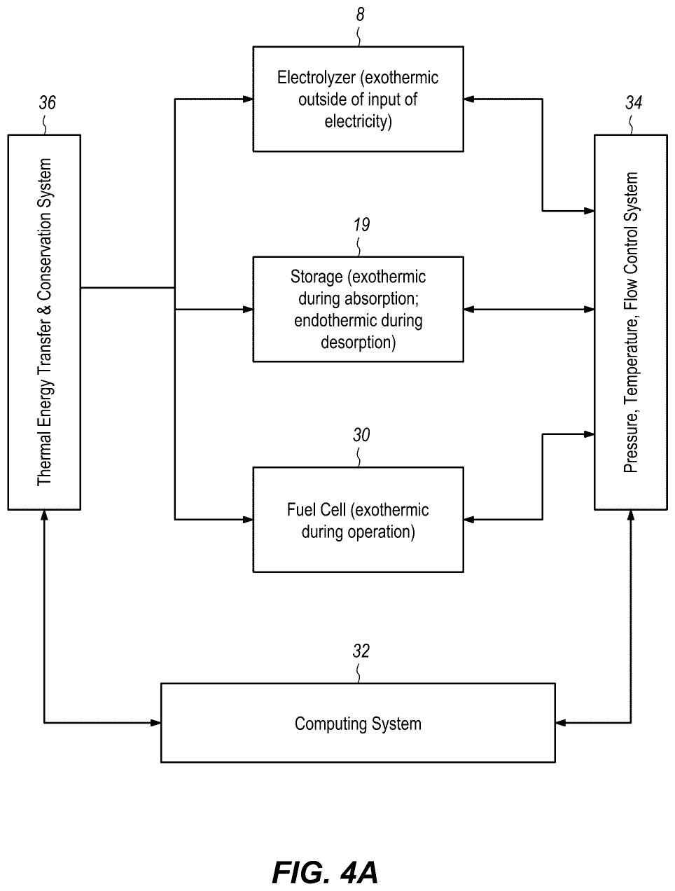

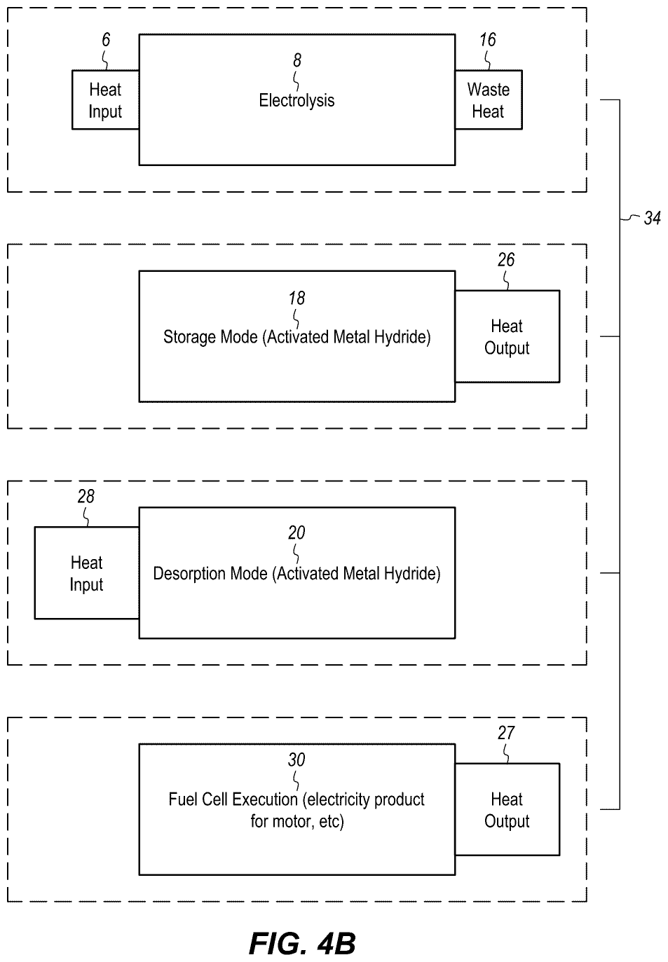

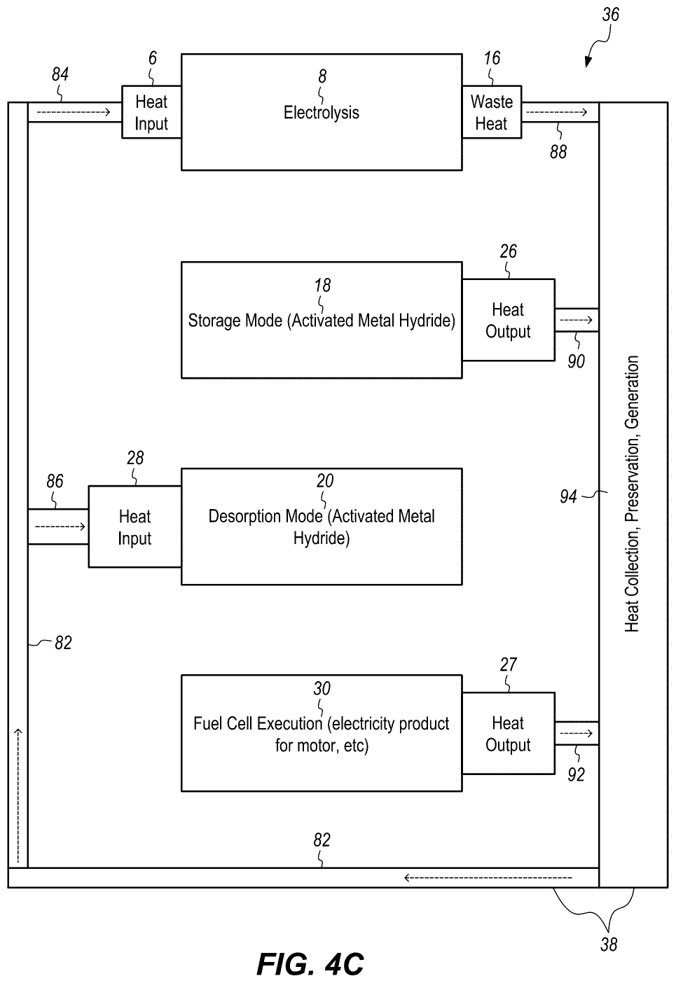

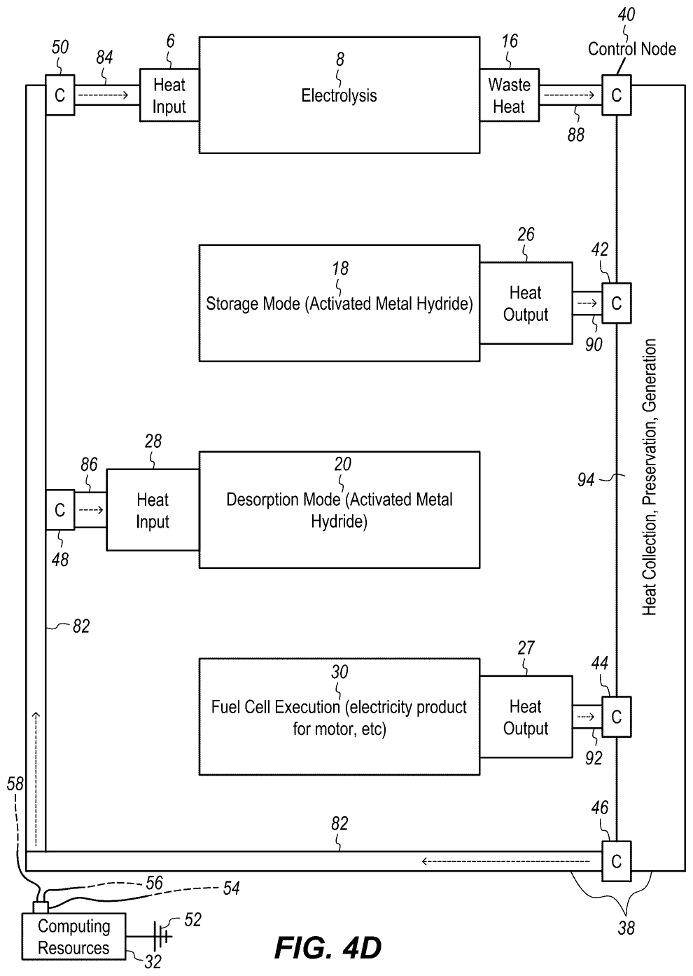

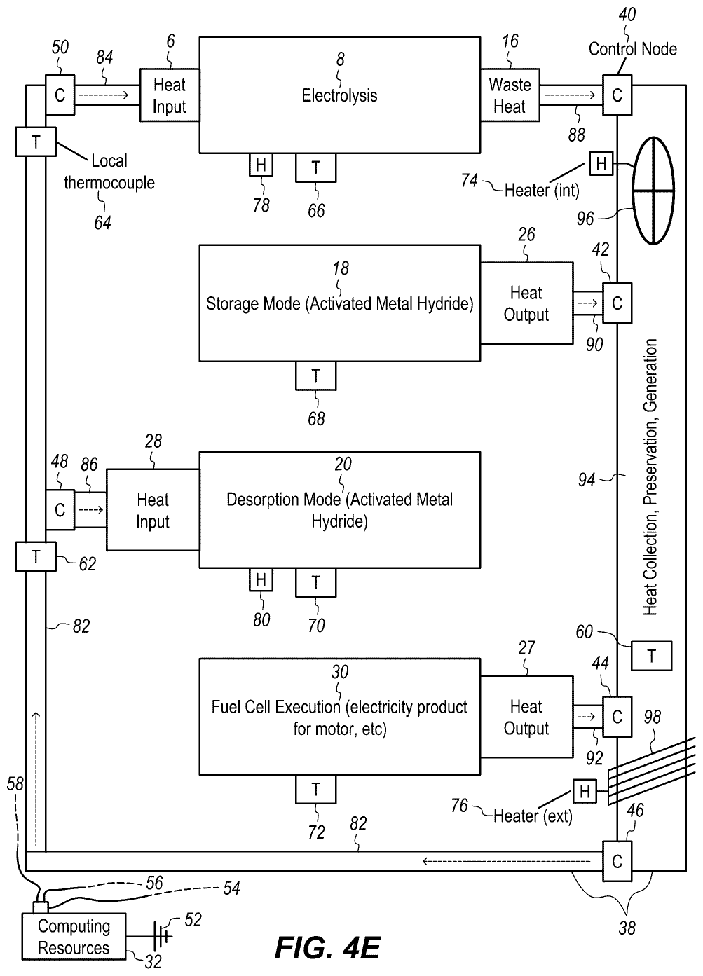

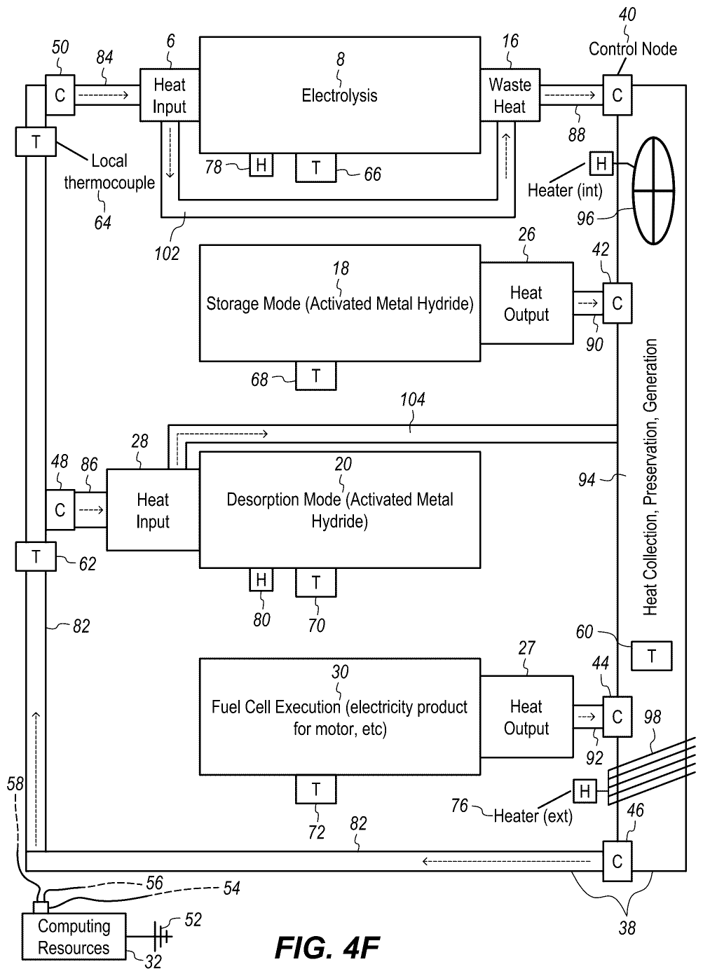

FIGS. 4A-4F, 5A-5B, 6A-6B, 7A-7B, 8A-8I, 9A-9D, and 10A-10B illustrate various aspects of configurations wherein thermal management configurations may be utilized to assist with process efficiency pertaining to a metal hydride storage configuration.

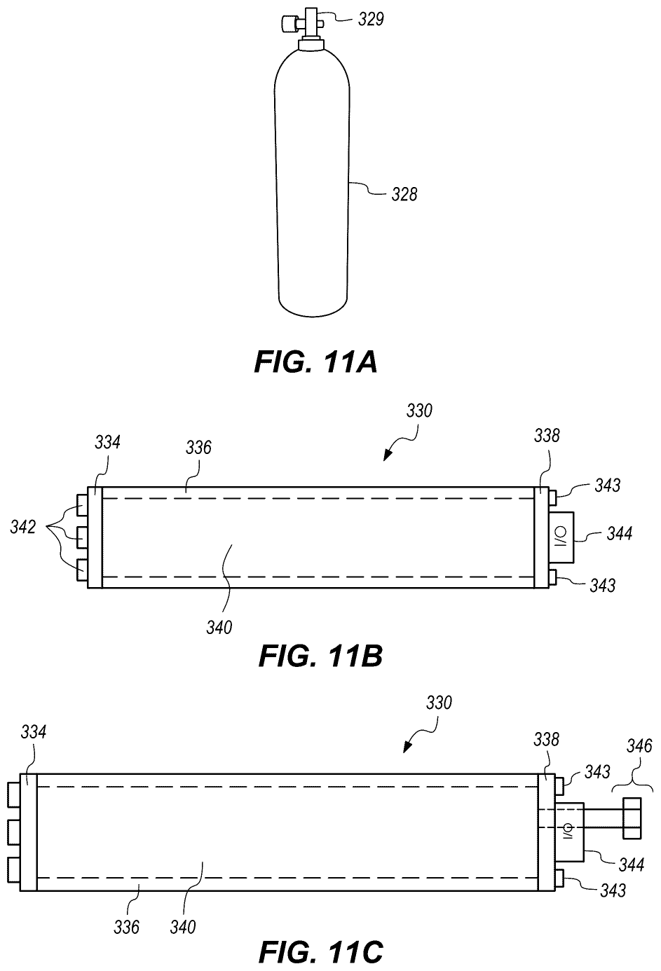

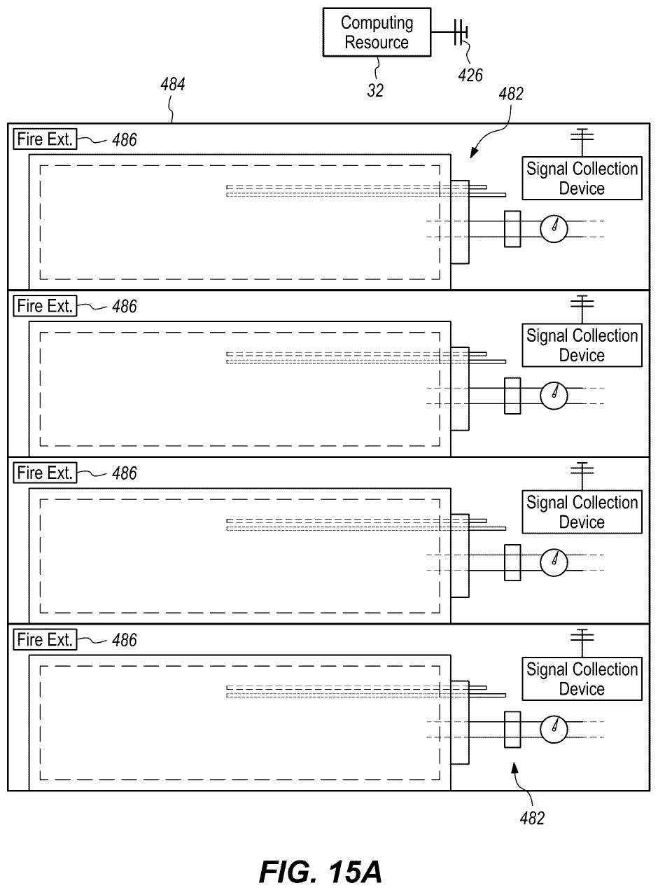

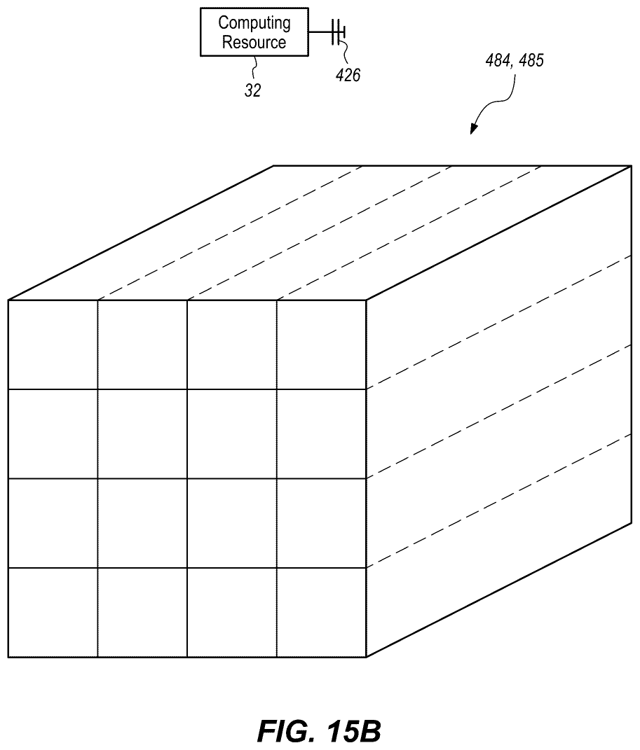

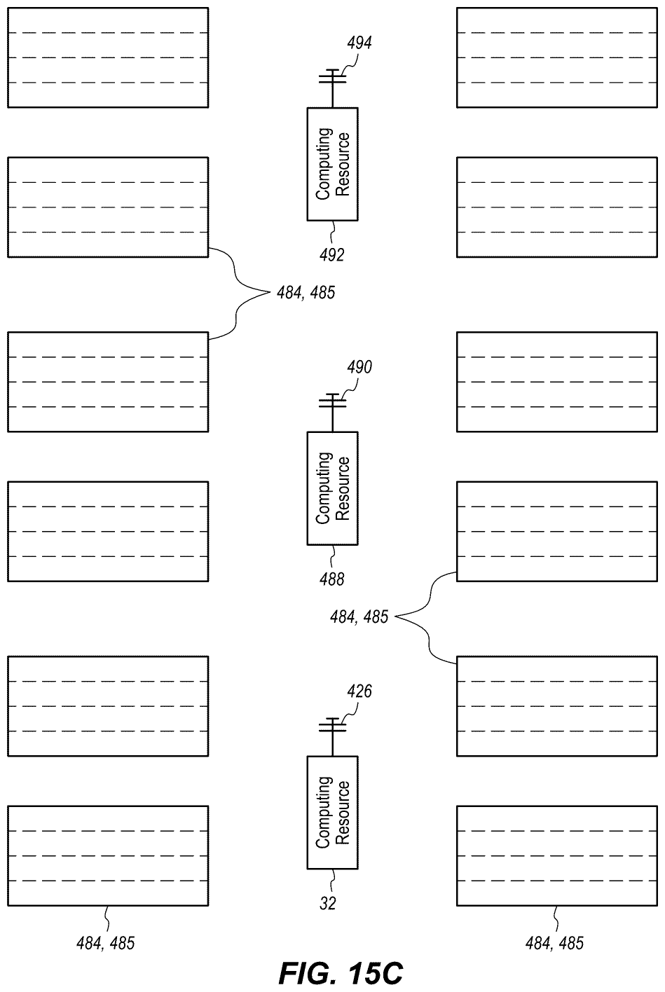

FIGS. 11A-11C, 12A-12L, 13A-13B, and 14A-14k illustrate various aspects of metal hydride storage vessel or module configurations, and FIGS. 15A-15C illustrate various aspects of assemblies thereof.

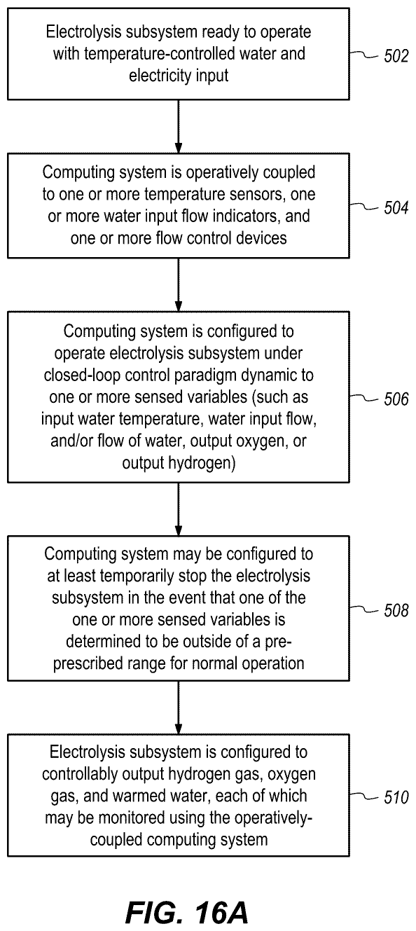

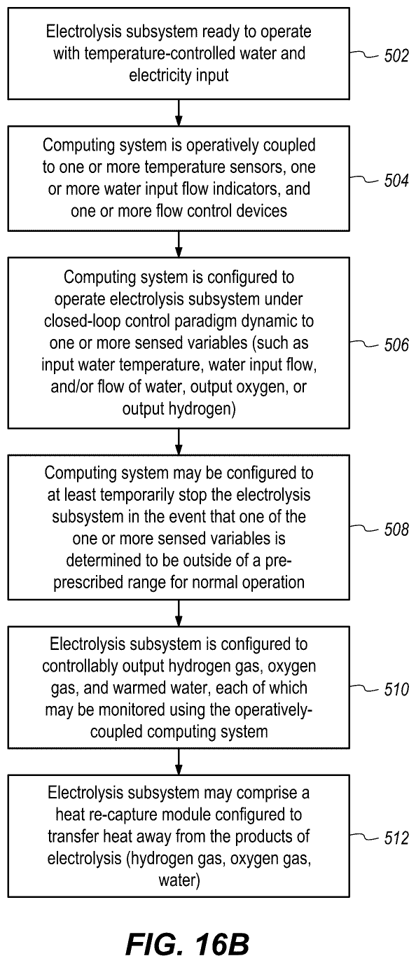

FIGS. 16A-16B, 17A-17B, 18, 19, and 20A-20C illustrate various aspects of process flows pertaining to metal hydride storage vessel or module configuration and integration.

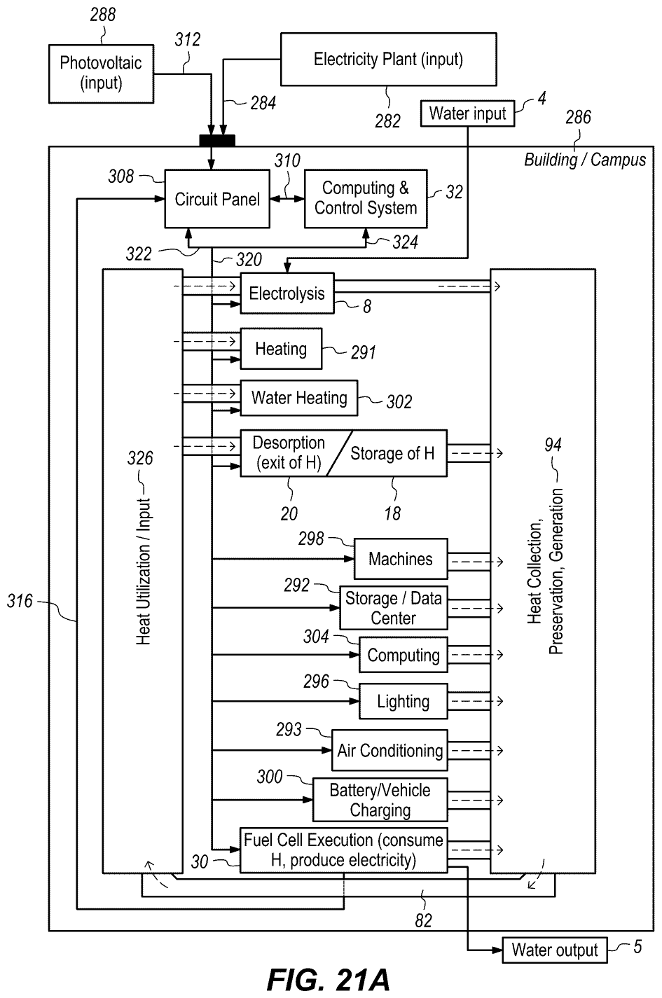

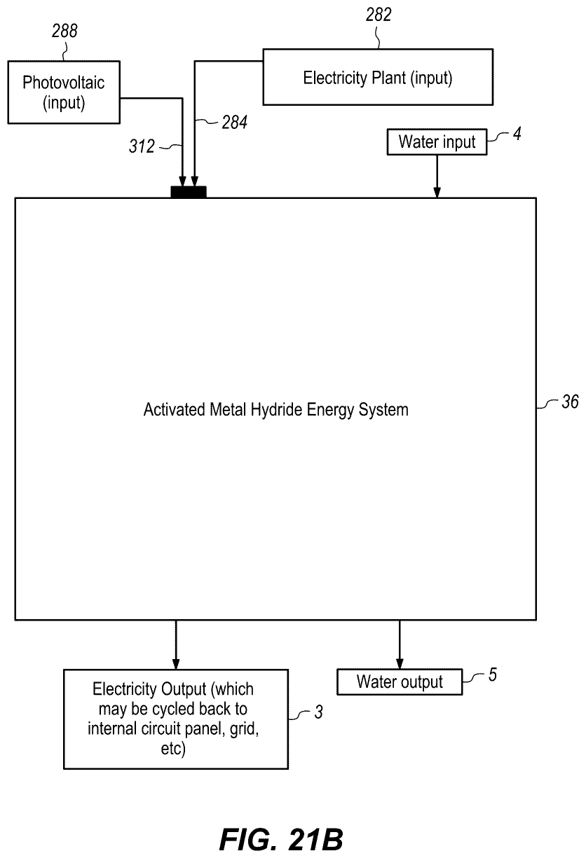

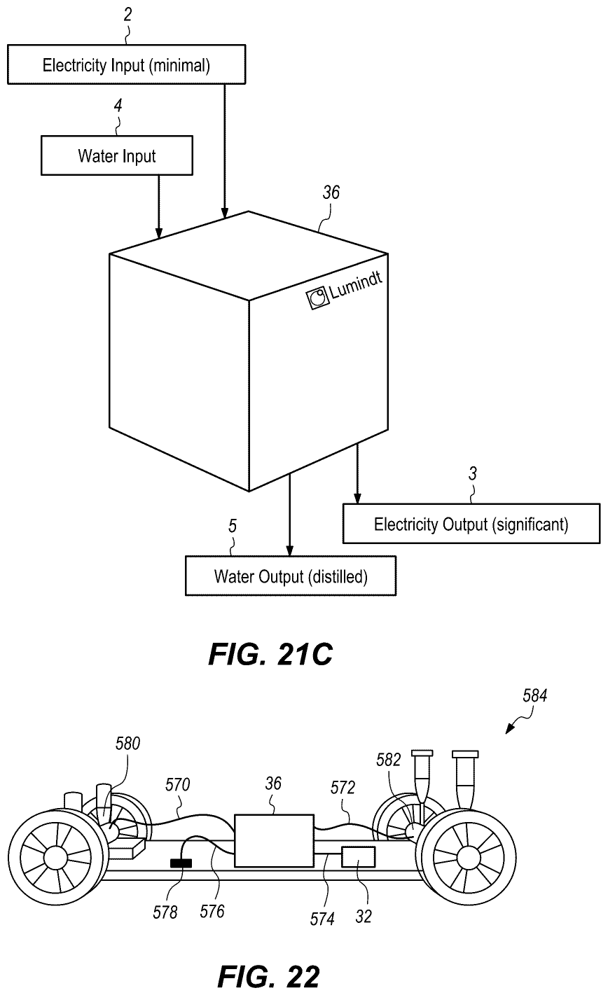

FIGS. 21A-21C illustrate various system integration configurations and details thereof.

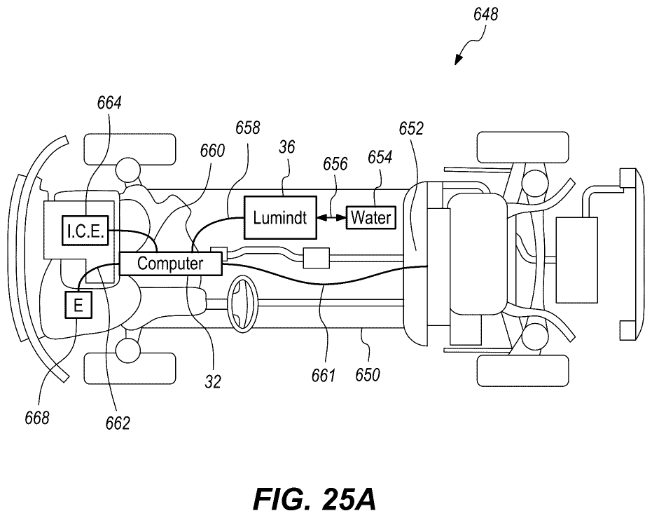

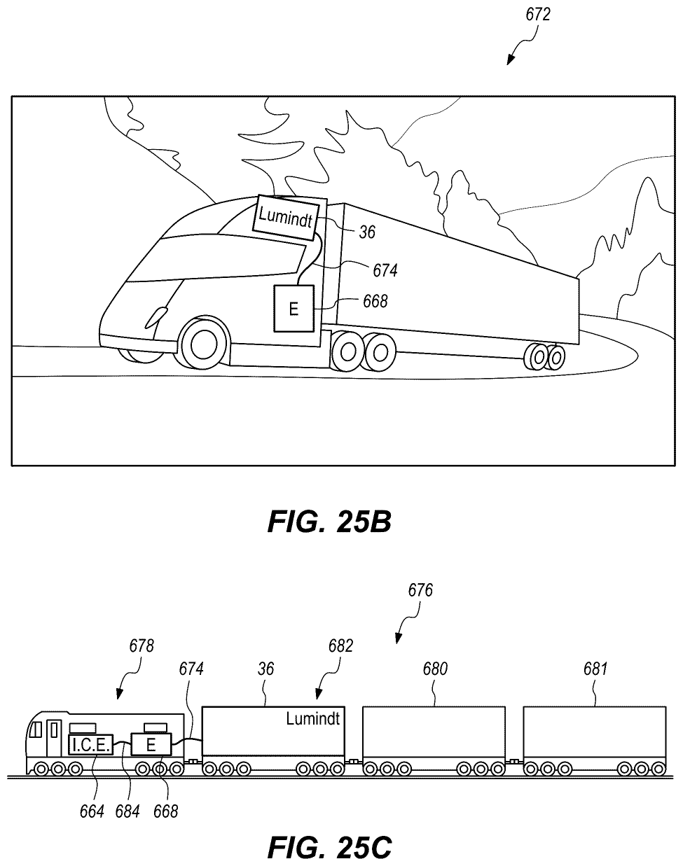

FIGS. 22 and 25A-25C illustrate aspects of various vehicle integrations pertaining to metal hydride storage vessel or module configurations.

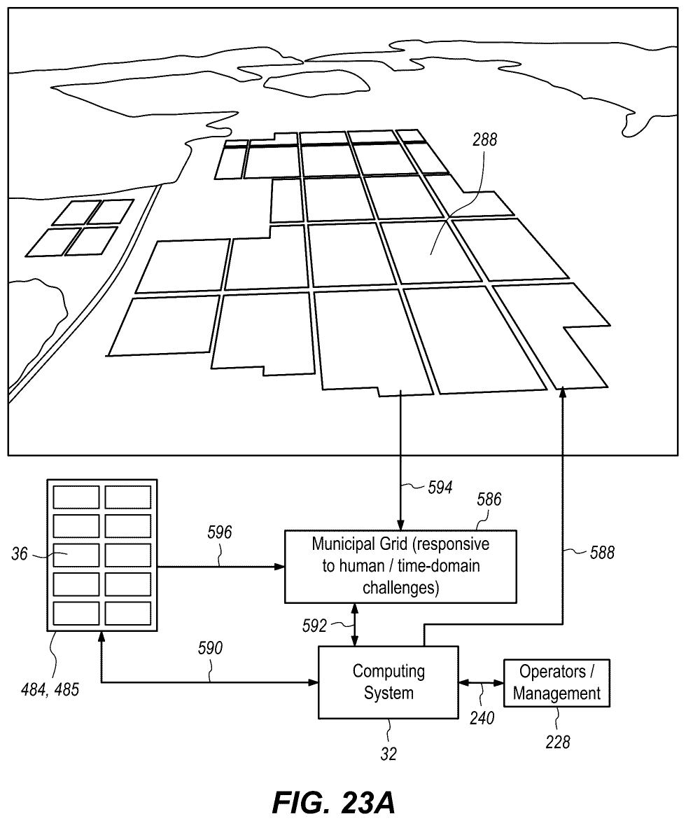

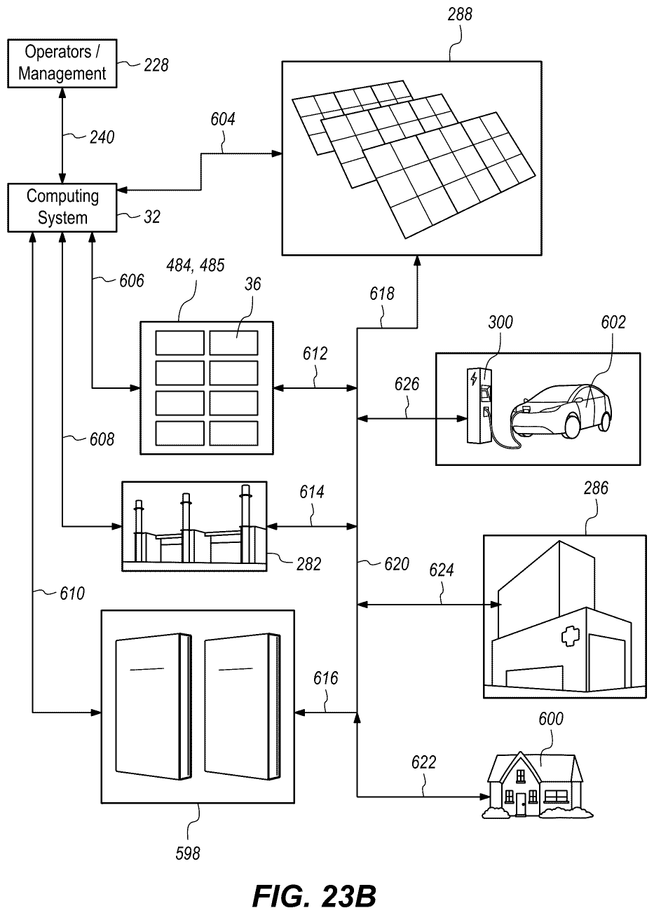

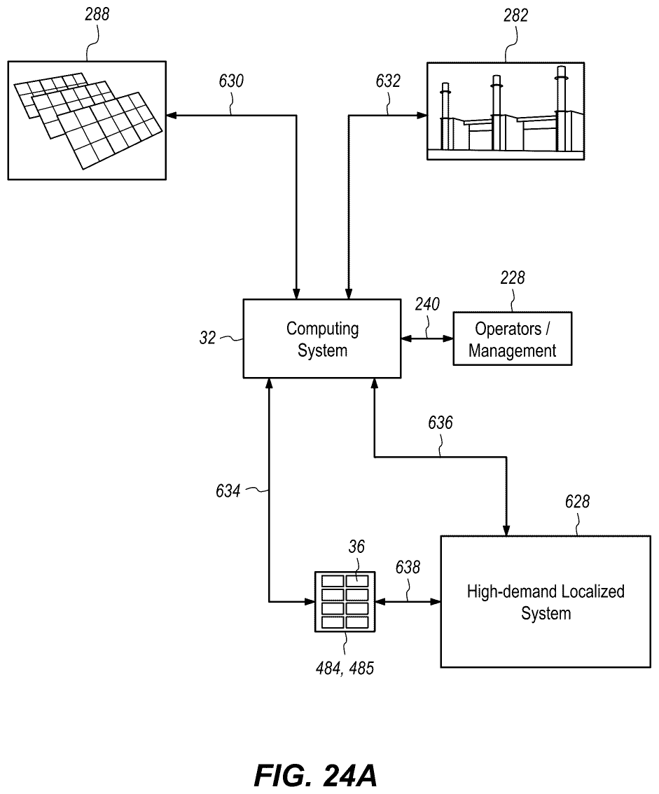

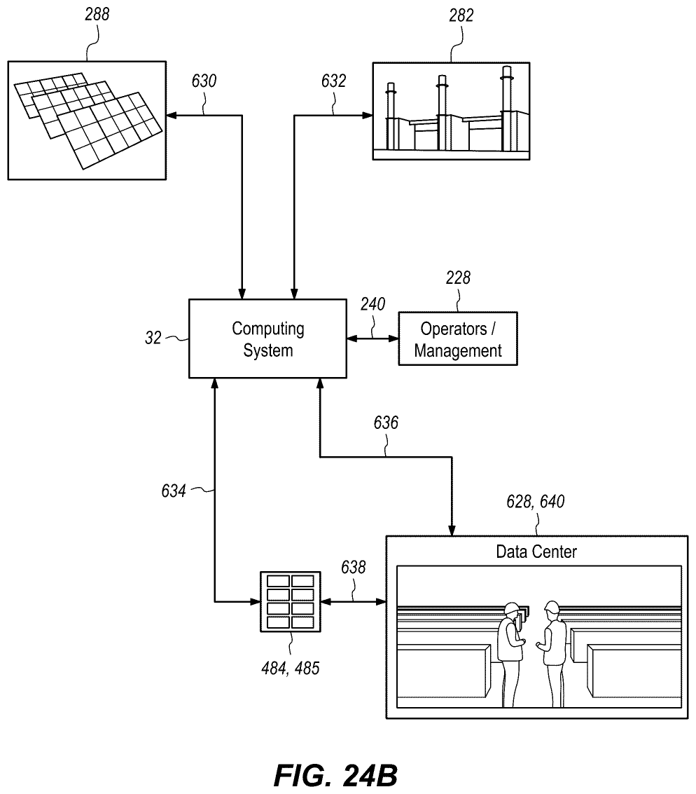

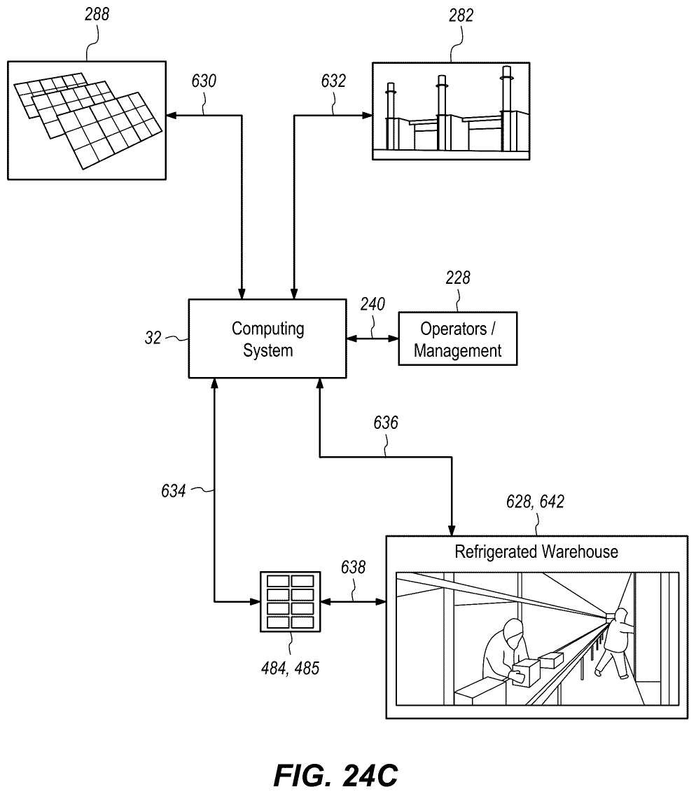

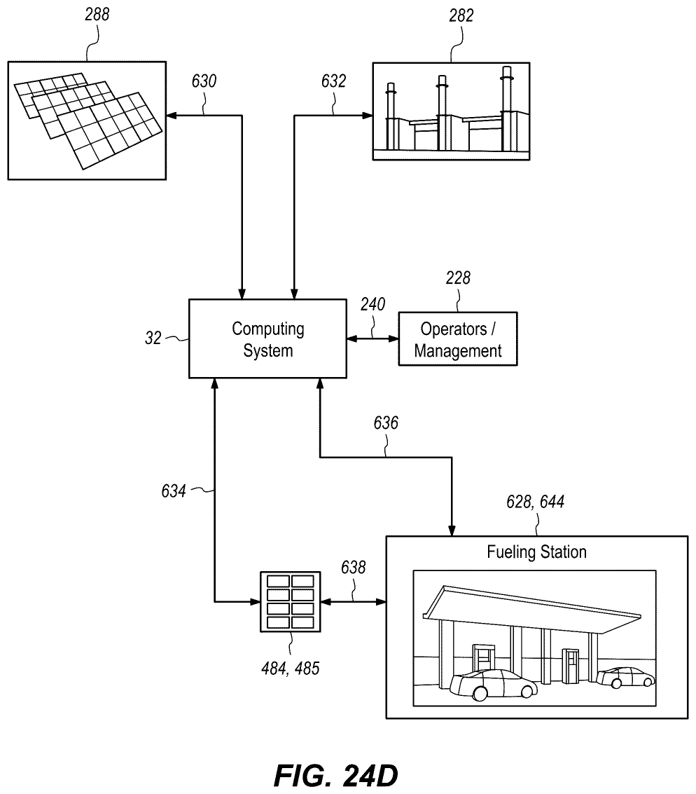

FIGS. 23A-23B and 24A-24D illustrate various aspects of system level controls and integrations for systems such as those with specific high demand components.

### SUMMARY

One embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; and a computing system operatively coupled to the electrolysis module, storage module, and fuel cell module and configured to coordinate operation of these modules relative to each other; wherein the electrolysis, storage, and fuel cell modules are thermally coupled such that heat energy released from one or more modules which may be at least transiently exothermic may be utilized by one or modules which may be at least transiently endothermic. The electrolysis module may comprise a proton exchange membrane electrolysis system comprising an electrolyte configured to conduct protons, separate one or more gases which may be produced, and electrically isolate an anode from a cathode. The electrolysis module may be configured to heat the intake water to enhance reactivity and a rate of production of the hydrogen gas. A temperature of the surplus water from the electrolysis module may become elevated relative to a temperature of the intake water. The system further may comprise an output sensor operatively coupled to the electrolysis module and configured to measure one or more factors correlated with the output of hydrogen gas. The output sensor may comprise a pressure sensor. The output sensor may comprise a flow meter. The output sensor may be operatively coupled to the computing system. The system further may comprise a temperature sensor operatively coupled to the electrolysis module and configured to measure a temperature correlated with operation of the electrolysis module. The temperature sensor may be selected from the group consisting of: a thermometer, a thermocouple, and an infrared detector. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The system further may comprise a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The system further may comprise a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module.

Another embodiment is directed to a metal hydride hydrogen storage module operatively coupled to a computing system and configured to controllably store, or alternatively release, hydrogen gas based at least in part upon commands from the computing system. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The system further may comprise a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material.

Another embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; a computing system operatively coupled to the electrolysis module, storage module, and fuel cell module and configured to coordinate operation of these modules relative to each other; and a first sensor and a second sensor, each operatively coupled to the computing system and configured to monitor one or more aspects of the storage module during operation in a manner such that a detecting error pertaining to the first sensor is at least partially uncorrelated with a detecting error pertaining to the second sensor, wherein the computing system is configured to utilize the at least partially uncorrelated errors of the first and second sensors to optimize characterization of operation of the storage module; wherein the electrolysis, storage, and fuel cell modules are thermally coupled such that heat energy released from one or more modules which may be at least transiently exothermic may be utilized by one or modules which may be at least transiently endothermic. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The system further may comprise a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The system further may comprise a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module. The first sensor may be a temperature sensor, and the second sensor may be a sensor selected from the group consisting of: a second temperature sensor, a pressure sensor, a strain gauge, a flow meter, and an image capture device.

Another embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; and a computing system operatively coupled to the electrolysis module, storage module, and fuel cell module and configured to coordinate operation of these modules relative to each other; wherein the electrolysis, storage, and fuel cell modules are thermally coupled such that heat energy released from one or more modules which may be at least transiently exothermic may be utilized by one or modules which may be at least transiently endothermic based at least in part upon a runtime instantiation of a neural network operated by the computing system and configured to automatically direct the heat energy and operate each module in accordance with a reward paradigm which may be specified by an operator. The neural network may be trained based at least in part upon historical operating data pertaining to a variable selected from the group consisting of: fuel cell module output demand, fuel cell temperature, storage module capacity status, storage module flow status, storage module temperature, storage module cycle history, storage module output flow rate, electrolysis module temperature, and electrolysis output flow rate. The neural network may be trained based at least in part upon simulated operating data pertaining to a variable selected from the group consisting of: fuel cell module output demand, fuel cell temperature, storage module capacity status, storage module flow status, storage module temperature, storage module cycle history, storage module output flow rate, electrolysis module temperature, and electrolysis output flow rate. The computing system may be configurable by the operator to reward a parameter selected from the group consisting of: electricity output from the fuel cell module; thermal cycle minimization; storage module storage/release cycle reversal minimization; time at maximum allowable temperature minimization; and hydrogen gas output from the storage module. The electrolysis module may comprise a proton exchange membrane electrolysis system comprising an electrolyte configured to conduct protons, separate one or more gases which may be produced, and electrically isolate an anode from a cathode. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The system further may comprise a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The system further may comprise a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module.

Another embodiment is directed to an integrated energy storage and distribution method, comprising: providing an electrolysis module configured to utilize intake electricity and intake water to output hydrogen gas, oxygen, and surplus water; providing a metal hydride hydrogen storage module configured to controllably store, or alternatively release, hydrogen gas; providing a fuel cell module configured to controllably intake hydrogen gas and output electricity and water vapor; and providing a computing system operatively coupled to the electrolysis module, storage module, and fuel cell module and configured to coordinate operation of these modules relative to each other; wherein the electrolysis, storage, and fuel cell modules are thermally coupled such that heat energy released from one or more modules which may be at least transiently exothermic may be utilized by one or modules which may be at least transiently endothermic. The electrolysis module may comprise a proton exchange membrane electrolysis system comprising an electrolyte configured to conduct protons, separate one or more gases which may be produced, and electrically isolate an anode from a cathode. The electrolysis module may be configured to heat the intake water to enhance reactivity and a rate of production of the hydrogen gas. A temperature of the surplus water from the electrolysis module may become elevated relative to a temperature of the intake water. The method further may comprise providing an output sensor operatively coupled to the electrolysis module and configured to measure one or more factors correlated with the output of hydrogen gas. The output sensor may comprise a pressure sensor. The output sensor may comprise a flow meter. The output sensor may be operatively coupled to the computing system. The method further may comprise providing a temperature sensor operatively coupled to the electrolysis module and configured to measure a temperature correlated with operation of the electrolysis module. The temperature sensor may be selected from the group consisting of: a thermometer, a thermocouple, and an infrared detector. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The method further may comprise providing a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The method further may comprise providing a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module.

Another embodiment is directed to a method comprising providing a metal hydride hydrogen storage module operatively coupled to a computing system and configured to controllably store, or alternatively release, hydrogen gas based at least in part upon commands from the computing system. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The method further may comprise providing a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material.

Another embodiment is directed to an integrated energy storage and distribution method, comprising: providing an electrolysis module configured to utilize intake electricity and intake water to output hydrogen gas, oxygen, and surplus water; providing a metal hydride hydrogen storage module configured to controllably store, or alternatively release, hydrogen gas; providing a fuel cell module configured to controllably intake hydrogen gas and output electricity and water vapor; providing a computing system operatively coupled to the electrolysis module, storage module, and fuel cell module and configured to coordinate operation of these modules relative to each other; and providing a first sensor and a second sensor, each operatively coupled to the computing system and configured to monitor one or more aspects of the storage module during operation in a manner such that a detecting error pertaining to the first sensor is at least partially uncorrelated with a detecting error pertaining to the second sensor, wherein the computing system is configured to utilize the at least partially uncorrelated errors of the first and second sensors to optimize characterization of operation of the storage module; wherein the electrolysis, storage, and fuel cell modules are thermally coupled such that heat energy released from one or more modules which may be at least transiently exothermic may be utilized by one or modules which may be at least transiently endothermic. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The method further may comprise providing a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The method further may comprise providing a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module. The first sensor may be a temperature sensor, and the second sensor may be a sensor selected from the group consisting of: a second temperature sensor, a pressure sensor, a strain gauge, a flow meter, and an image capture device.

Another embodiment is directed to an integrated energy storage and distribution method, comprising: providing an electrolysis module configured to utilize intake electricity and intake water to output hydrogen gas, oxygen, and surplus water; providing a metal hydride hydrogen storage module configured to controllably store, or alternatively release, hydrogen gas; providing a fuel cell module configured to controllably intake hydrogen gas and output electricity and water vapor; and providing a computing system operatively coupled to the electrolysis module, storage module, and fuel cell module and configured to coordinate operation of these modules relative to each other; wherein the electrolysis, storage, and fuel cell modules are thermally coupled such that heat energy released from one or more modules which may be at least transiently exothermic may be utilized by one or modules which may be at least transiently endothermic based at least in part upon a runtime instantiation of a neural network operated by the computing system and configured to automatically direct the heat energy and operate each module in accordance with a reward paradigm which may be specified by an operator. The neural network may be trained based at least in part upon historical operating data pertaining to a variable selected from the group consisting of: fuel cell module output demand, fuel cell temperature, storage module capacity status, storage module flow status, storage module temperature, storage module cycle history, storage module output flow rate, electrolysis module temperature, and electrolysis output flow rate. The neural network may be trained based at least in part upon simulated operating data pertaining to a variable selected from the group consisting of: fuel cell module output demand, fuel cell temperature, storage module capacity status, storage module flow status, storage module temperature, storage module cycle history, storage module output flow rate, electrolysis module temperature, and electrolysis output flow rate. The computing system may be configurable by the operator to reward a parameter selected from the group consisting of: electricity output from the fuel cell module; thermal cycle minimization; storage module storage/release cycle reversal minimization; time at maximum allowable temperature minimization; and hydrogen gas output from the storage module. The electrolysis module may comprise a proton exchange membrane electrolysis system comprising an electrolyte configured to conduct protons, separate one or more gases which may be produced, and electrically isolate an anode from a cathode. The storage module may comprise a metallic storage vessel configured to securely and removably contain a predetermined portion of metal hydride material. The metallic storage vessel may comprise 316L stainless steel. The metallic storage vessel may comprise a substantially cylindrical body portion. The metallic storage vessel may comprise one or more substantially circular end portions removably coupled to the substantially cylindrical body portion. The one or more substantially circular end portions may be removably coupled to the substantially cylindrical body portion by a plurality of removable fastener components. The plurality of removable fastener components may comprise a plurality of high-strength bolts and nuts. The metallic storage vessel may comprise one or more substantially circular end portions coupled to the substantially cylindrical body portion using a metallic welded interface. The metallic storage vessel may comprise an input/output interface configured to allow controlled entrance and exit of hydrogen gas from the metallic storage vessel. The metallic storage vessel may comprise a thermal energy transfer module configured to controllably add or remove heat from the metallic storage vessel. The thermal energy transfer module may comprise a flow circuit configured to facilitate controllable flow of a thermal transfer fluid. The flow circuit may be configured to enter and exit an interior volume defined by the metallic storage vessel to contain the metal hydride material. The flow circuit may be configured to enter and exit the interior volume through a plurality of apertures defined through a portion of the metallic storage vessel. The interior volume may be defined by a body portion and one or more end portions coupled to the body portion, and wherein the plurality of apertures are defined through an end portion coupled to a body portion. The flow circuit may comprise a tubing assembly defining a flow pathway therethrough. The tubing assembly may comprise an at least partially helical shape. The tubing assembly may comprise an assembly of substantially straight elongate tubing portions coupled by shorter arcuate tubing portions. The flow pathway may comprise a unitary pathway of flow defined through the tubing assembly. The flow pathway may comprise a plural pathway of flow defined through the tubing assembly such that flow is directed through a plurality of two or more parallel branches of the tubing assembly. The tubing assembly may be coupled to one or more surface expansion structures configured to increase thermal conduction between the tubing assembly and portions of the metal hydride material which may be positioned adjacent the tubing assembly. The thermal energy transfer module may comprise a resistive heating element. The resistive heating element may be coupled across at least a portion of the metallic storage vessel such that a portion of the resistive heating element is positioned in an indwelling manner within a portion of an interior volume defined by the metallic storage vessel to contain the metal hydride material. The resistive heating element may be coupled to at least one external aspect of the metallic storage vessel to provide controlled resistive heating directly thereto. The resistive heating element may comprise an at least partially helical shape. The resistive heating element may comprise a discrete element configured to be in contact with an external portion of the metallic storage vessel. The resistive heating element may comprise a perimetric heating cuff element. The perimetric heating cuff element may comprise a patterned heating element. The perimetric heating cuff element may comprise a matrix heating element. The metal hydride material may be an AB2 classified metal hydride. The AB2 classified metal hydride may comprise titanium. The titanium metal hydride may comprise hydralloy C5 with a stoichiometry configuration of about Ti 0.95 Zr 0.05 Mn 1.46 V 0.45 Fe 0.09. The hydralloy C5 within the metallic storage vessel may be activated for hydrogen storage and release using an activation pressurization with hydrogen gas of about 60 bars. The hydralloy C5 within the metallic storage vessel may be activated for hydrogen storage and release using an activation pressurization with hydrogen gas of about 60 bars in situ within the particular metallic storage vessel. The metal hydride material may be an AB classified metal hydride. The AB classified metal hydride may comprise titanium. The titanium metal hydride may comprise ferrotitanium (FeTi). The ferrotitanium within the metallic storage vessel may be activated for hydrogen storage and release using an activation pressurization with hydrogen gas of about 60 bars and an activation temperature of about 400 degrees C. The ferrotitanium within the metallic storage vessel may be activated for hydrogen storage and release using an activation pressurization with hydrogen gas of about 60 bars and an activation temperature of about 400 degrees C. in situ within the particular metallic storage vessel. The method further may comprise providing a sensor operatively coupled to the metallic storage vessel and computing system, the sensor configured to provide information pertaining to the operation of the metallic storage vessel. The sensor may comprise a pressure sensor. The sensor may comprise a temperature sensor. The temperature sensor may be selected from the group consisting of: a thermometer, a thermocouple, and an infrared detector. The sensor may comprise a flow meter. At least a portion of the sensor may be coupled across at least a portion of the metallic storage vessel such that the portion of the sensor is positioned in an indwelling manner within a portion of an interior volume defined by the metallic storage vessel to contain the metal hydride material. The fuel cell module may comprise a proton exchange membrane fuel cell stack. The method further may comprise providing a sensor operatively coupled to the fuel cell module and computing system, the sensor configured to provide information pertaining to the operation of the fuel cell module. The sensor may be selected from a group consisting of: a temperature sensor, a current sensor, and a pressure sensor. The sensor may be a temperature sensor selected from the group consisting of: a thermometer, a thermocouple, and an infrared detector. The computing system may be configured to coordinate operation of the electrolysis module, storage module, and fuel cell module in a closed loop control configuration such that hydrogen gas is stored and/or released from the storage module dynamic at least in part to demands for electricity made upon the fuel cell module. The storage module may comprise a plurality of metallic storage vessels coupled together in a common rack structure, each of which is operatively coupled to the computing system, fuel cell module, and electrolysis module.

Another embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; a computing system operatively coupled to the electrolysis module, storage module, and fuel cell module and configured to coordinate operation of these modules relative to each other; and an energy demand subsystem operatively coupled to the metal hydride storage module; wherein the electrolysis, storage, and fuel cell modules are thermally coupled such that heat energy released from one or more modules which may be at least transiently exothermic may be utilized by one or modules which may be at least transiently endothermic. The energy demand subsystem may be selected from the group consisting of: a building, a vehicle, an energy grid, a hydrogen distribution system, a battery, a data center, and a refrigeration system.

Another embodiment is directed to an integrated energy storage and distribution system, comprising: an electrolysis module configured to utilize intake electricity and intake water to output hydrogen gas, oxygen, and surplus water; a metal hydride hydrogen storage module configured to controllably store, or alternatively release, hydrogen gas; a fuel cell module configured to controllably intake hydrogen gas and output electricity and water vapor; a computing system operatively coupled to the electrolysis module, storage module, and fuel cell module and configured to coordinate operation of these modules relative to each other; and an energy source subsystem operatively coupled to the metal hydride storage module; wherein the electrolysis, storage, and fuel cell modules are thermally coupled such that heat energy released from one or more modules which may be at least transiently exothermic may be utilized by one or modules which may be at least transiently endothermic. The energy source subsystem may be selected from the group consisting of: a photovoltaic source, a windpower system, a hydroelectric power system, a battery, a vehicle regenerative braking system.

### DETAILED DESCRIPTION

This application claims priority to six U.S. provisional patent applications (U.S. Provisional Patent Application Ser. No. 63/581,601 titled “HYDRONIC THERMALLY COUPLED METAL HYDRIDE AND PROTON EXCHANGE MEMBRANE ELECTROLYZER SYSTEM”, filed on Sep. 8, 2023, and U.S. Provisional Patent Application Ser. No. 63/581,626 titled “THERMALLY COUPLED FULL POWER-TO-POWER ELECTROLYZER-METAL HYDRIDE-FUEL CELL HYDRONIC THERMAL MANAGEMENT SYSTEM”, filed on Sep. 8, 2023, and U.S. Provisional Patent Application Ser. No. 63/581,206 titled “METAL HYDRIDE VESSEL DESIGN FOR A HYDRONIC THERMAL MANAGEMENT SYSTEM”, filed on Sep. 7, 2023, and U.S. Provisional Patent Application Ser. No. 63/581,338 titled “A HYDRONIC THERMALLY COUPLED METAL HYDRIDE AND PROTON EXCHANGE MEMBRANE FUEL CELL SYSTEM”, filed on Sep. 8, 2023, and U.S. Provisional Patent Application Ser. No. 63/551,501 titled “THERMALLY-COUPLED METAL HYDRIDE ENERGY SYSTEMS AND METHODS”, filed on Feb. 8, 2024, and U.S. Provisional Patent Application Ser. No. 63/554,889 titled “THERMALLY-COUPLED METAL HYDRIDE ENERGY SYSTEMS AND METHODS”, filed on Feb. 16, 2024), each of which is incorporated by reference herein in its entirety. Referring to FIG. 1, an electrolyzer (8) system or module is illustrated having inputs of warmed (6) water (4) and electricity (2), and outputs of oxygen gas (10), hydrogen gas (12), water (14), and mild heat (16) from the associated exothermic reaction of deconstructing water molecules as noted above. With many systems and instantiations, this produced thermal energy is wasted, exhausted, or generally dissipated into the environment, and generally also the thermal energy input to warm (6) the input water (4) for enhanced electrolysis efficiency is from a heating element requiring power input for such purpose.

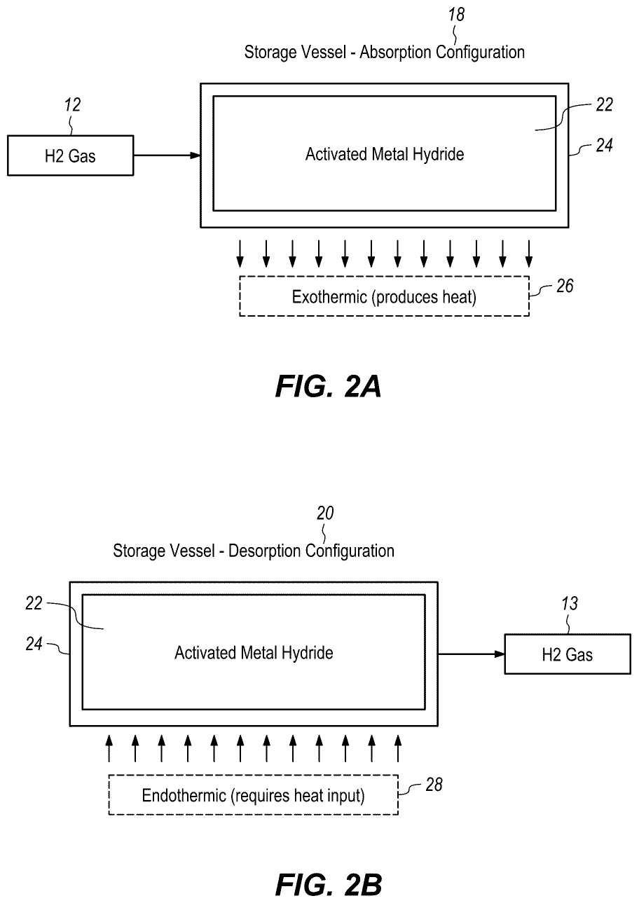

Referring to FIG. 2A, a storage vessel or module in absorption configuration (18; i.e., in a configuration wherein it is intaking and storing hydrogen) is illustrated, with hydrogen gas (12) being controllably directed into the storage vessel (24), which may be configured to contain an activated metal hydride material (22), such as in powdered form. The activated metal hydride material may be loaded into the vessel, activated, and configured to controllably and stably store the hydrogen within the vessel (24) for later utilization, such as with a fuel cell or fuel cell module (as described below). As noted in FIG. 2A, the process of intaking hydrogen into the activated metal hydride storage configuration is exothermic (26; heat producing), providing another opportunity for thermal management within a broader system.

Referring to FIG. 2B, when an activated metal hydride (22) storage vessel or module (24) is being utilized in a desorption (20) configuration (i.e., it is controllably exiting hydrogen), the process generally is endothermic (28), requiring input heat to assist in the exiting of the hydrogen gas (13) for use in another subsystem, such as a fuel cell.

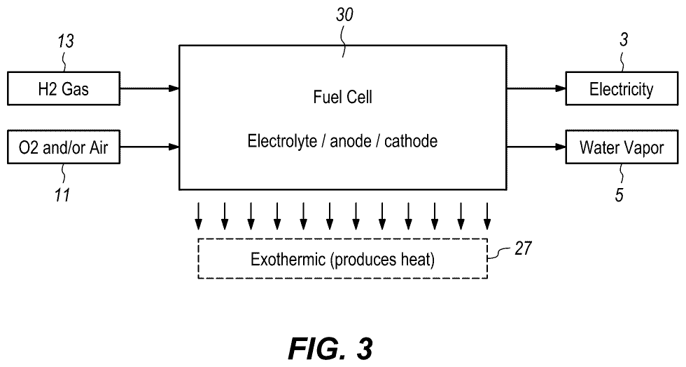

Referring to FIG. 3, a fuel cell (30) is shown with hydrogen gas (13) and oxygen gas and/or air (11) as inputs, and electricity (3) and water vapor (5) as outputs, along with produced heat (27; exothermic). Fuel cells continue to be attractive in various systems for utilizing storage hydrogen to assist in clean operation, such as in mobile (for example, in the vehicle marketed by Toyota Motor Company as the Mirai™) and non-mobile power systems.

Referring to FIG. 4A, and back to FIGS. 1, 2A, 2B, and 3, given the various thermal requirements, inputs, and outputs pertaining to a system which features electrolysis (8) to produce usable hydrogen, storage (19) of hydrogen, desorption (19) and transfer out of hydrogen, and consumption of hydrogen, such as in a fuel cell (30), there is an opportunity to controllably manage thermal assets relative to these various components, such as via use of a computing system or computing resources (32), which may be intercoupled to various elements to monitor variables such as pressure, temperature, and flow (34), and to transfer and conserve (36) thermal energy generally. In other words, rather than having four discrete functions as shown in FIG. 4A which may consume and/or utilize heat energy (for example, the electrolysis system or module 8 is shown with heat input 6 and waste heat 16; in storage mode 18, an activated metal hydride cell outputs heat 26; in desorption mode 20, an activated metal hydride cell may have heat input 28; a fuel cell module 30 in operational or execution mode, such as to produce output power for an electric motor or the like, produces heat output 27) a unified approach may be utilized with controlled thermal coupling of various elements to provide overall efficiency gains.

Thus referring to FIG. 4C, an intercoupled system configuration (36) is shown wherein waste heat (16) may be transferred away from an electrolysis component (8) toward a heat collection, preservation, and/or generation reservoir (94). Similarly, heat output (26) from an activated metal hydride storage vessel module in storage mode (18) may be transferred to the heat collection, preservation, and/or generation reservoir (94), along with heat output (27) from intercoupled fuel cell module (30) execution. Heat energy from the heat collection, preservation, and/or generation reservoir (94) may be transferred using a physical heat system of reservoirs and/or conduits (38) to become utilized as heat input (6, 28) to elements such as the electrolysis and desorption mode activated metal hydride storage module elements (8, 20, respectively), thus obviating the need for independent heat input for those processes. Heat may be collected, such as in a physical vessel or containment reservoir (94), and moved through conduits (82, 86, 84, 88, 90, 92; preferably insulated conduits such as those described below) utilizing fluids such as water, oils, oil/paraffin hybrids, and various other so-called “heat transfer fluids” available from providers such as Eastman™ or Dynalene™, for example, and may be selected depending upon viscosity versus temperature charts relative to the pertinent conduit and reservoir or other container geometries to optimize for particular usages (in other words, a heat transfer medium ideally will flow efficiently through a targeted conduit within the given prescribed temperature ranges for usage).

Referring to FIG. 4D, another system variation is illustrated featuring further components, such as a plurality of control nodes (40, 42, 44, 46, 48, 50) configured to be operatively coupled (such as via wireless connectivity 52, such as via IEEE type 802.11 connectivity, nearfield, Bluetooth, or the like; and/or via direct wired connectivity, for example 54, 56, 58) with a computing system or computing resources (32) for operational control. For example, each control node may represent a digital or analog control system local node for operating a component (such as a flow control valve, pump, heater, etc) or utilizing a sensor (such as a thermocouple, infrared image capture device, pressure sensor, etc). For example, referring to FIG. 4E, these and other local control nodes may be utilized, for example, to: monitor and/or control waste heat (16) coming through an exit conduit (88) from electrolysis (8) using a thermocouple; control a submerged or internal heating element (96) within a heat collection reservoir (94) using a heater control element (74), for example to maintain a prescribed level of heat and/or viscosity; to monitor and/or control heat output (26) coming through an exit conduit (90) from a storage modality of the activated metal hydride system (18); to monitor temperature using a sensor (60; such as a thermocouple, infrared imaging device, etc) configured to assist in making temperature determinations pertaining to the heat collection reservoir (94); to monitor heat output (27) coming through an exit conduit (92) pertaining to fuel cell execution (30); to monitor and/or control an external (i.e., not submerged; for example, may be a resistive heating coil engaged around the exterior of the collection reservoir 94) heating element (98) using a heater control element (76), for example to provide closed-loop control to the heating in the region or subsystem; to monitor temperatures at various locations (62, 64, 66, 68, 70, 72, for example); and to monitor flow and/or pressure at various locations (such as input conduit locations 84, 86; to provide, for example, closed loop control pertaining to routing of heat energy into electrolysis 8 heat input 6, and/or desorption mode 20 heat input 28). FIG. 4F illustrates a configuration similar to that of FIG. 4E, with the addition of additional heat routing and preservation conduits (102, 104, for example) to preserve and route remaining heat which may not be needed or utilized from and around electrolysis (8; 102), and from and around a desorption mode configuration (20; 104), for example, such that flow may be circulated around the system (38) of conduits and reservoirs (94; 82, 84, 86, 88, 90, 92), such as via one or more pumps which may be operatively coupled to a control node or directly to the computing system (32).

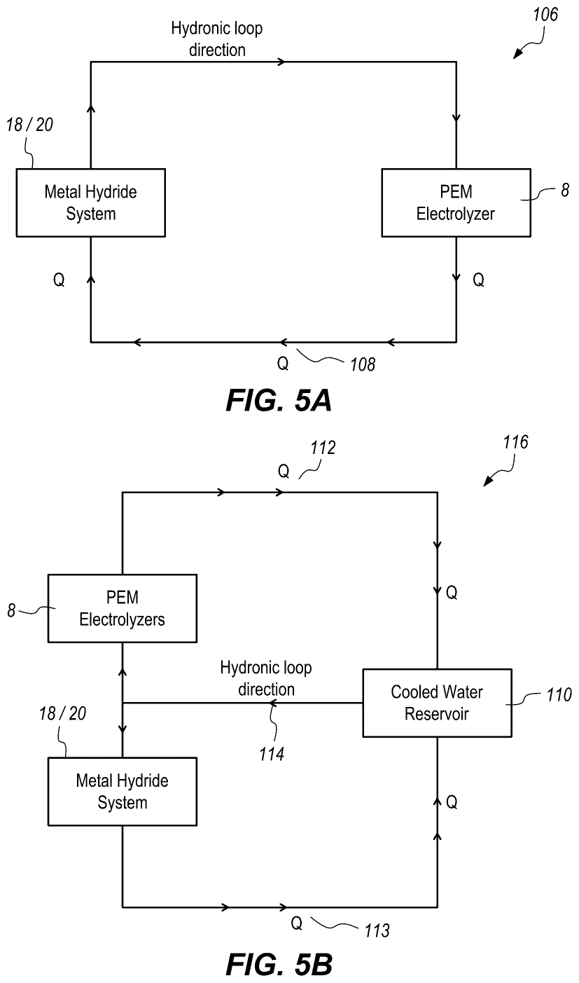

Referring to FIGS. 5A-7B, various heat preservation and routing diagrams are illustrated for various system instantiations involving various combinations of electrolysis (8), storage/desorption (18/20), and fuel cell execution (30).

Referring to FIGS. 5A and 5B, a hydronic system (106) configuration is shown that thermally couples a proton exchange membrane (“PEM”) type electrolyzer (8) and a metal hydride system storage/desorption element (18/20). Such configuration may comprise a network of closed-loop tubes, reservoirs, pumps, by-pass valves, modulation valves, and a control system to effectively control the mass flow (108) rate of the working fluid and monitor the temperatures of the different subcomponents of the system. The network of tubes may be configured to run through key heat generation sources pertaining to both the metal hydride system (18/20) and PEM electrolyzer (8) to efficiently recover and transfer heat in the system. In the metal hydride system (18/20), the loops may be configured to run internally through the metal hydride vessels, interfacing directly with the metal hydride material which releases heat during the hydrogen absorption process and uses heat during the hydrogen desorption process. Pertaining to the electrolyzer (8), the loops may be configured to run through electrolyzer stacks which may comprise the PEM element as the oxidation reaction in the anode and the reduction reaction in the cathode are both exothermic. When hydrogen is absorbed by the metal hydride vessel (18/20) in an exothermic absorption/storage reaction, the heat generated during this process may be transferred via internal vessel heat exchangers to the hydronic system. As noted above, this heat may be transferred to the electrolyzer (8) if it is below its optimal temperature operating range, thereby making the electrolyzer more efficient. Similarly, when the metal hydride system is desorbing hydrogen in an endothermic reaction, waste heat may be recovered from the electrolyzer and transferred to the metal hydride vessels' internal heat exchangers to maintain fast desorption kinetics of hydrogen gas release from the metal hydride material. Mass flow rate and temperature sensors may be placed at the inlets and outlets of the metal hydride system as well as the electrolyzer stacks and configured to provide real-time data back to the control and computing system for regulating precise thermal control and optimization of the system.

FIG. 5A illustrates one closed loop of the thermal management system wherein the hydronic system may be configured to transfer waste heat generated by the electrolyzer (8) to the metal hydride system (18/20) during the desorption process (for example, to exit hydrogen to a fuel cell for consumption therein). This loop (108) may require a pump to keep the water/heat-transfer-fluid circulated and may run through the PEM electrolyzer stacks to efficiently recover the waste heat. It may then be circulated through the loop and travel internally through the metal hydride vessels via internal vessel heat exchangers to efficiently transfer the waste heat to the metal hydride material which may be undergoing an endothermic reaction. Such waste heat may be used as the source heat necessary to maintain the desorption reaction, resulting in heightened energy efficiency. This water or heat-transfer-fluid may then continue to circulate back through the PEM electrolyzer stacks to repeat the process.

FIG. 5B illustrates another closed loop system (116) embodiment wherein the hydronic system may be configured to simultaneously cool both the electrolyzer (8) and the metal hydride system (18/20) using various controlled flow (112, 114, 113) configurations. Water or heat-transfer-fluid may be pumped from a cold reservoir to pass through tubes that interface with the PEM electrolyzer stacks and the metal hydride vessels via internal heat exchangers when the metal hydride material is undergoing an exothermic absorption reaction. These loops may be designed to run through key heat generation sources, to effectively carry heat away as it is generated by both the PEM electrolyzer and the metal hydride system back to the cold water reservoir, where the water or heat-transfer-fluid in the reservoir is being continuously cooled. Excess waste heat that may be generated in the PEM electrolyzer and the metal hydride system may be transferred back to the hydronic system, where it can be used for various different purposes. This facilitates various applications, such as those interfacing with heat pumps, water heating, or space heating, for example. Thus, this hydronic thermal management configuration may act as both an electric and thermal energy storage system.

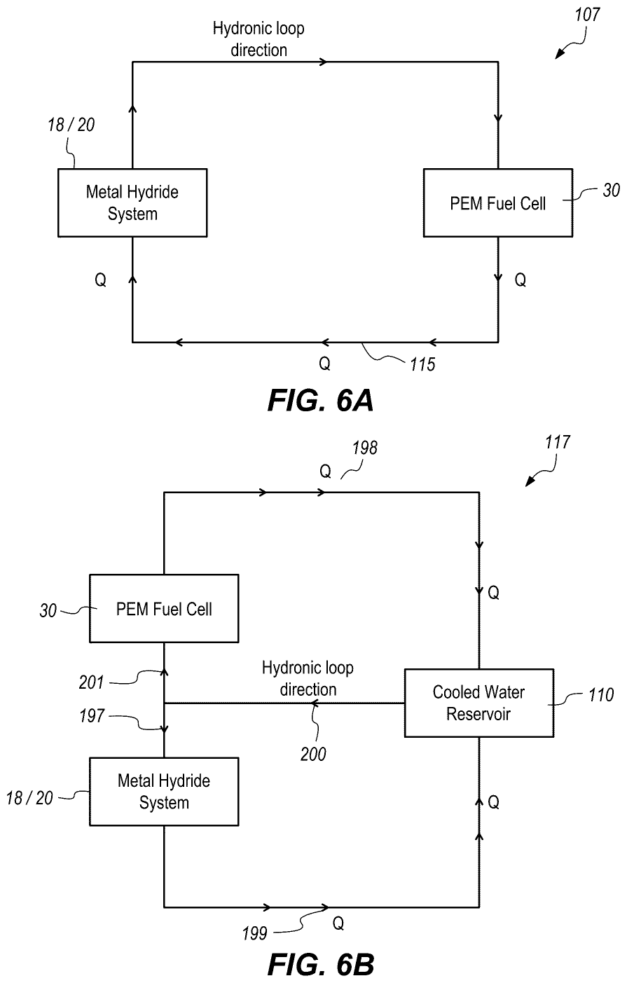

Referring to FIGS. 6A and 6B, configurations are illustrated wherein hydronic systems may be utilized to improve efficiencies by thermally coupling the a fuel cell (30; such as a PEM fuel cell) and metal hydride system (18/20). Referring to FIGS. 6A and 6B, embodiments (107, 117) may comprise networks of closed-loop tubes, reservoirs, pumps, by-pass valves, modulation valves, and a control system to effectively control the mass flow (element 115 in FIG. 6A; elements 197, 198, 199, 200, 201 in FIG. 6B) rates of the working fluid (for example, water or other heat transfer fluid) and monitor the temperatures of the different subcomponents of the system. A network of tubes may be configured to run through key heat generation sources in both the metal hydride system (18/20) and PEM fuel cell (30) to efficiently recover and transfer heat in the system. In the metal hydride system, the loops may be configured to run internally through the metal hydride vessels interfacing directly with the metal hydride material which releases heat during the hydrogen absorption process and uses heat during the hydrogen desorption process. In the PEM fuel cell, the loops may be configured to run through the fuel cell stacks as the anode reaction of hydrogen oxidation is exothermic and the cathode reaction of oxygen reduction is also exothermic. When hydrogen is absorbed by the metal hydride vessel (18/20) in the exothermic absorption reaction, heat generated during this process may be transferred via the internal vessel heat exchangers to the hydronic system, and this heat may be transferred to the PEM fuel cell (30) if it is below its optimal temperature operating range, thereby providing for closed-loop optimization of the fuel cell (30). Similarly, when the metal hydride system (18/20) is desorbing hydrogen which is an endothermic reaction, waste heat may be recovered from the PEM fuel cell and transferred to the metal hydride vessels' internal heat exchangers to maintain fast desorption kinetics of hydrogen gas from the metal hydride material. Mass flow rate and temperature sensors may be placed at the inlets and outlets of the metal hydride system (18/20) as well as the fuel cell (30) stacks. These sensors may be utilized to provide real-time data back to the computing and/or control system to regulate precise thermal control of the system.

Referring again to FIG. 6A, one closed loop embodiment (107) of a thermal management system configuration is illustrated, wherein the hydronic system may be configured to transfer waste heat generated by the PEM fuel cell (30) to the metal hydride (18/20) absorption system during the desorption process. This loop may require a pump (for example, intercoupled to the computing or control system) to keep the water or other heat transfer fluid circulating and may be configured to run through the PEM fuel cell stacks to efficiently recover waste heat. The heat transfer fluid then may be circulated through the loop using the pipe and travel internally through the metal hydride vessels through internal vessel heat exchangers to efficiently transfer the waste heat to the metal hydride material which may be undergoing an exothermic reaction. This water or other heat transfer fluid may then continue to circulate back through the PEM fuel cell to repeat the process.

FIG. 6B illustrates another closed loop configuration (117) of the thermal management system where the hydronic system simultaneously cools both the PEM fuel cell and the metal hydride system. Water is pumped from a cold water reservoir to pass through tubes that interface with the PEM fuel cell stacks and the metal hydride vessels via internal vessel heat exchanges when the metal hydride material is undergoing an exothermic reaction. These loops will carry waste heat generated by both the PEM fuel cell and the metal hydride system back to the cold water reservoir, where the water in the reservoir is being continuously cooled. Excess waste heat that is generated in the PEM fuel cell (30) and metal hydride system (18/20) may be transferred back to the hydronic loop, where it can be used for various purposes as well. This facilitates various permutations and/or combinations for example, such as interfacing with heat pumps, water heating, or space heating (i.e., such thermal management configurations may be utilized to act as both an electric and thermal energy storage system).

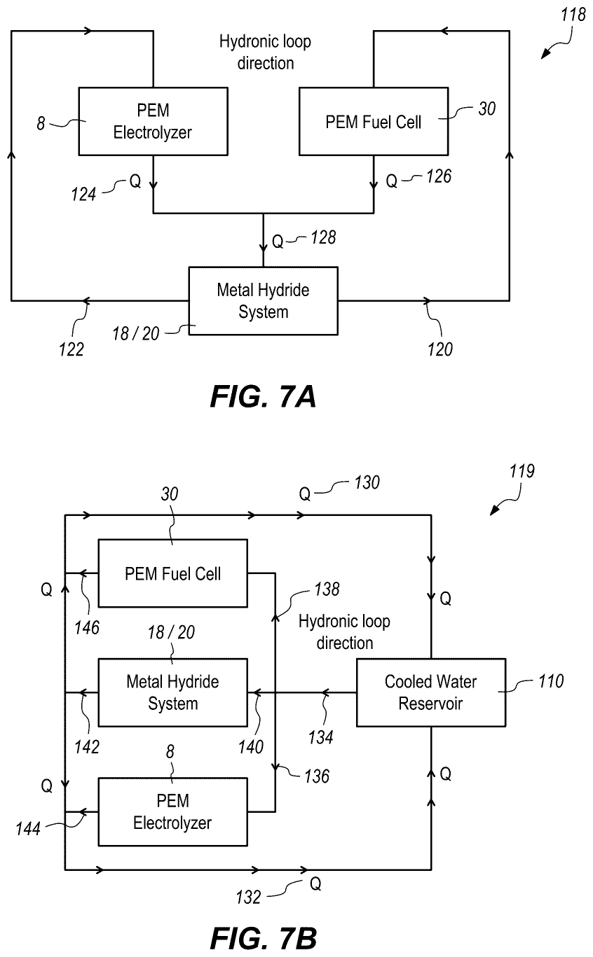

Referring to FIGS. 7A and 7B, embodiments (118, 119) of hydronic systems that thermally couple various elements, such as an electrolyzer (8), metal hydride system (18/20), and/or fuel cell (30), are illustrated. Such systems may comprise a network of closed-loop tubes, reservoirs, pumps, by-pass valves, modulation valves, and a control and/or computing system to effectively control the mass flow (elements 120, 122, 124, 126, 128 of FIG. 7A; elements 130, 132, 134, 136, 138, 140, 142, 144, 146 of FIG. 7B) rate of the working heat transfer fluid and monitor the temperatures of the different subcomponents of the system. The network of tubes may be configured to run through key heat generation sources in the metal hydride system, PEM electrolyzer, and PEM fuel cell to efficiently recover and transfer heat in the system. In the metal hydride system (18, 20), the loops may be configured to run internally through the metal hydride vessels, interfacing directly with the metal hydride material which releases heat during the hydrogen absorption process and uses heat during the hydrogen desorption process. In the PEM electrolyzer (8) and PEM fuel cell (30), the loops may be configured to run through the electrolyzer and fuel cell stacks as the reactions that occur in each respective anodes and cathodes of the systems are exothermic. When hydrogen is absorbed by the metal hydride vessel (18/20) in an exothermic absorption reaction, the heat generated during this process may be transferred via internal vessel heat exchangers to the hydronic system. This heat may be transferred to the PEM electrolyzer (8) or the PEM fuel cell (30) if they are below their respective optimal temperature operating ranges, thereby providing for efficiency gains with the electrolyzer and fuel cell. Similarly, when the metal hydride system (18/20) is desorbing hydrogen in an endothermic reaction, waste heat can be recovered from the PEM electrolyzer and PEM fuel cell and transferred to the metal hydride vessels' internal heat exchangers to maintain fast desorption kinetics of hydrogen gas release from the metal hydride material. Mass flow rate and temperature sensors may be placed at the inlets and outlets of the metal hydride system (18/20) as well as the electrolyzer (8) and fuel cell (30) stacks. These sensors may be configured to provide real-time data back to the control system to regular precise thermal control of the hydronic system.

FIG. 7A illustrates one closed-loop configuration (118) of a thermal management system where the hydronic system transfers waste heat generated by the PEM electrolyzer (8) and PEM fuel cell (30) to the metal hydride system (18/20) during the desorption process. This loop may be configured to have a pump to keep the water or other heat transfer fluid circulated and may be configured to run through the PEM electrolyzer stacks and PEM fuel cell stacks to efficiently recover the waste heat. The fluid then may be circulated through the loop and travel internally through the metal hydride vessels via internal vessel heat exchangers to efficiently transfer the waste heat to the metal hydride material which will be undergoing an endothermic reaction. This waste heat may be used as the source heat necessary to maintain the desorption reaction, resulting in enhanced energy efficiency. This water or other heat transfer fluid then may continue to circulate back through the PEM electrolyzer (8) stacks and PEM fuel cell (30) stacks to repeat the process.

FIG. 7B illustrates another closed loop configuration (119) of a thermal management system where the hydronic system may be configured to simultaneously cool (110) the PEM electrolyzer (8), PEM fuel cell (30), and the metal hydride system (18/20). Water or other heat transfer fluid may be pumped from a cold reservoir to pass through tubes that interface with the PEM electrolyzer stacks, PEM fuel cell stacks, and the metal hydride vessels via internal heat exchangers when the metal hydride material is undergoing an exothermic absorption reaction. These loops may be designed to run through heat generation sources, to effectively carry heat away as it is generated by the PEM electrolyzer (8), PEM fuel cell (30), and the metal hydride system (18/20) back to the cooling reservoir (110), where the water or other heat transfer fluid in the reservoir may be continuously cooled. Excess waste heat that is generated in the PEM electrolyzer, PEM fuel cell, and the metal hydride system may be be transferred back to the hydronic system, where it can be used for various different purposes. This facilitates additional configurations, such as those interfacing with heat pumps, water heating, or space heating, for example. Such a thermal management configuration thus may act as both an electric and thermal energy storage system.

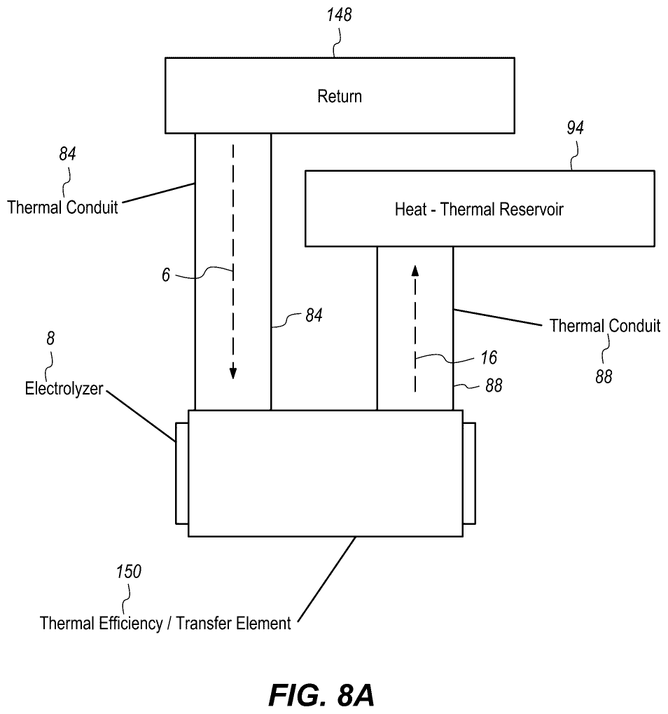

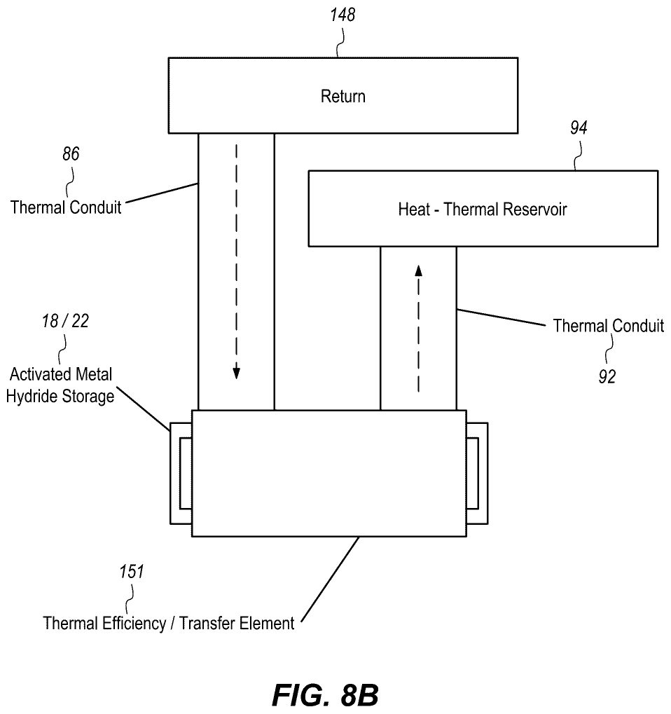

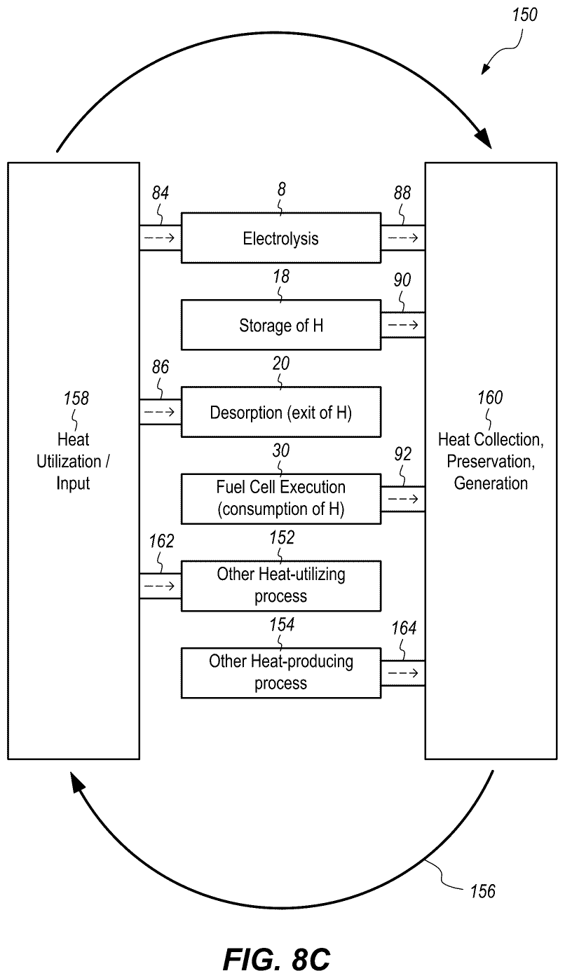

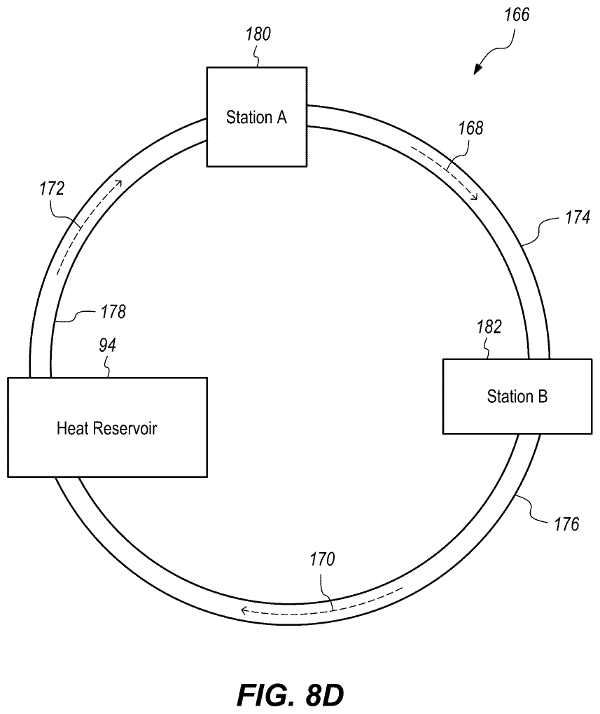

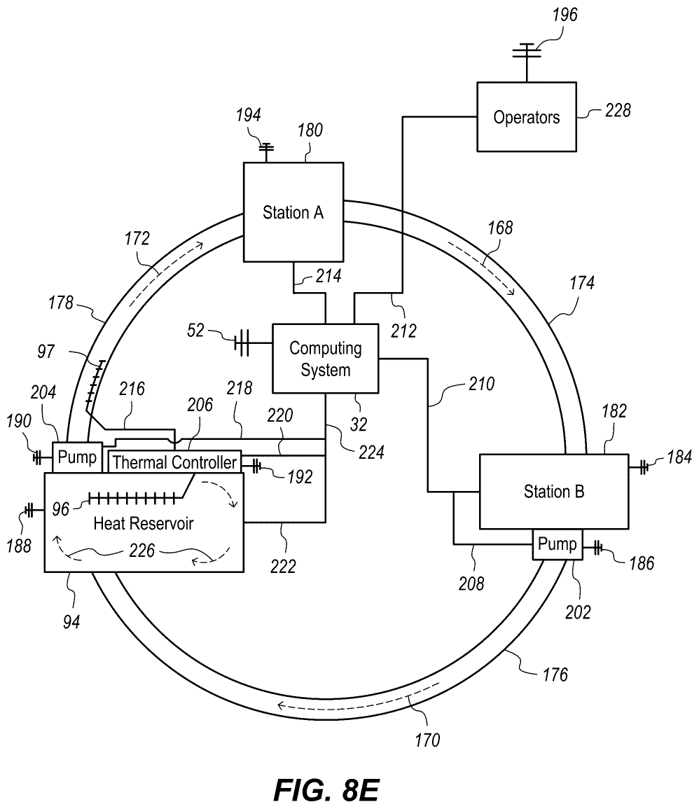

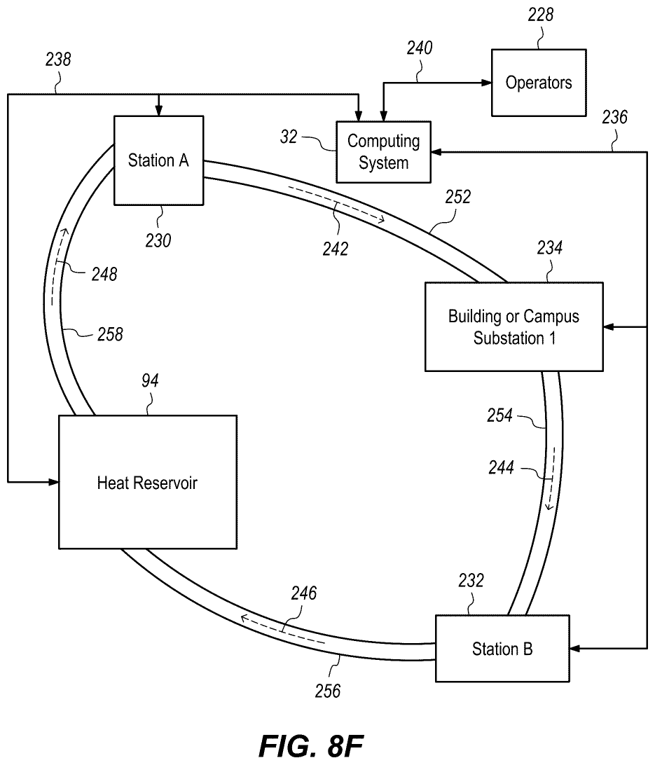

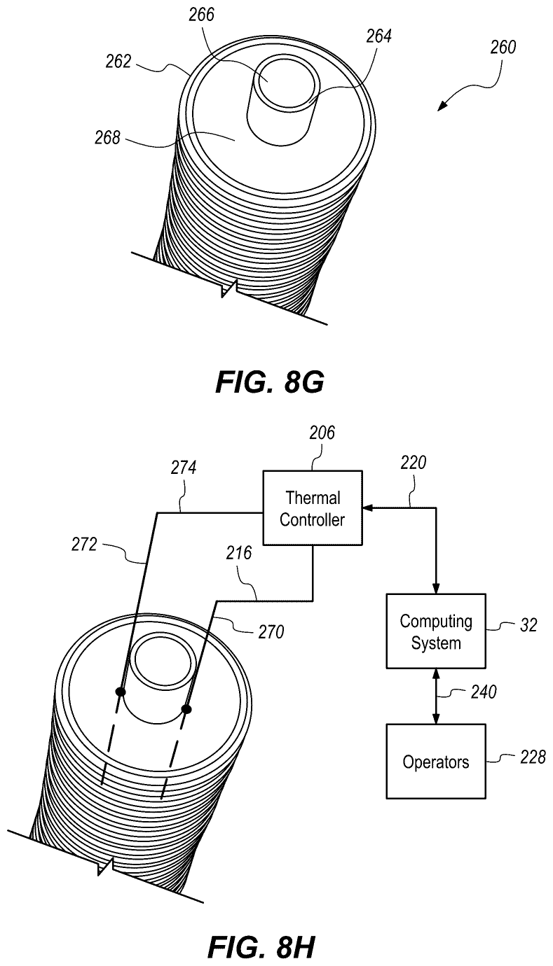

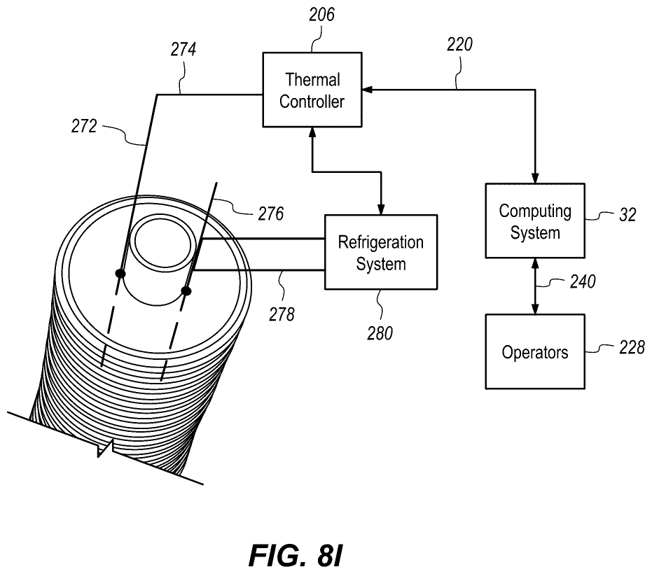

Referring to FIG. 8A, another schematic illustrates that a component such as an electrolyzer (8) may be operatively coupled to a thermal efficiency or thermal transfer element (150), such as a heat transfer conduit or collector, so that heat may be transferred away (16), such as through a thermal conduit (88), toward other elements such as a thermal reservoir (94); further, heat energy may be returned (148) through (6) a separate thermal conduit (84), to facilitate efficiencies and avoidance of other previously independent heating processes or sub-processes, such as input water warming for electrolysis (8). FIG. 8B illustrates a parallel schematic pertaining to an activated metal oxide hydrogen storage or desorption component (18/22), wherein a thermal transfer element (151) may be utilized to exit heat away through a thermal conduit (92), and/or bring in heat through a return circuit (148) via a thermal conduit (86) when appropriate in the storage/desorption cycling.

FIG. 8C illustrates a multi-component thermal transfer cycle (156) configuration showing a heat collection, preservation, and generation element (160) configured to receive, such as via conduit (88, 90, 92, 164), heat from various operational elements (8, 18, 30, 154, respectively), and to preserve and cycle the heat into utilization (158) on a functional input side of the cycle, wherein heat may be directed into various processes, such as via conduit (84, 86, 162), as shown.

Referring to FIG. 8D, in various configurations, such as in a factory, power station, home, commercial building, or building campus, there may be relatively long distances between components, and preferably an efficiency system may be configured to route heat energy for maximum utility and preservation. FIG. 8D illustrates a configuration wherein a heat transfer fluid may be controllably flowed (168, 170, 172) between functional components through conduits (174, 176, 178, respectively); such as from a first functional station (180) to a section functional station (182), to a third functional station which may be a heat reservoir (94), for example.

Referring to FIG. 8E, an embodiment similar to that of FIG. 8D is illustrated, with the addition of further system componentry for precision operation, such as one or more pumps (202, 204), one or more controllable heating elements (96, 97) which may be operatively coupled (such as by direct wired connection 216 or wireless as noted above) to a thermal controller (206) and configured to provide controlled heating to elements such as a heat reservoir (94) or one or more conduits (178). The various elements may be operatively coupled to one or more computing systems (32), and to one or more operators or operator workstations or computing devices (228) through direct wired (212, 214, 210, 208, 224, 222, 216, 218, 220) or wireless communication technologies (196, 184, 186, 194, 52, 192, 190, 188). In various embodiments, heat conducting fluid within a given enclosure or reservoir may be not only controllably heated but also circulated (226), such as via operatively coupled recirculation pump, to maintain flow dynamics and operational homogeneity.

Referring to FIG. 8F, a configuration is illustrated featuring a heat reservoir (94), first station (230), second station (232), and substation (234) which may be positioned in non-proximal locations, such as in different rooms, different buildings, or, for example, distributed in different locations about a campus of buildings. Heat energy may be transferred through the controlled flow (242, 244, 246, 248) of heat transfer fluid through conduits (252, 254, 256, 258, respectively), all under the operationally coupled control of one or more intercoupled (238, 236) computing systems (32), which may be operationally coupled (240) to one or more user or operator systems (228) for observation and functionality such as manual operation or override of various system components.

Referring to FIGS. 8G, 8H, and 8I, to assist in moving, preserving, and maintaining thermal energy between operational nodes, conduits may comprise configurations such as a heat transfer fluid flow lumen (266) defined by an inner structural wall (264), with a thermally-insulating layer (268) positioned between the inner structural wall (264) and an outer structural wall (262), as shown in FIG. 8G. The embodiment of FIG. 8H is similar to that of FIG. 8G, and also has the addition of one or more sensors (272) operatively coupled (274) to a thermal controller (206) and configured to be positioned within or closely adjacent to thermal energy transfer fluid which may pass through the lumen (266) of the conduit assembly, as well as one or more heating elements (270) operatively coupled (216) to the thermal controller (206) and configured to controllably heat adjacent or in-contact fluids passing through the lumen (266). The thermal controller (206) may be operatively coupled (220) to one or more computing assets (32) which may be operatively coupled (240) to one or more operator systems (228) to provide operator information and control.

FIG. 8I illustrates a configuration similar to that of FIG. 8H, but with a refrigeration/cooling circuit (278) coupled to a cooling element (276) positioned to controllably cool adjacent or in-contact fluids passing through the lumen (266).

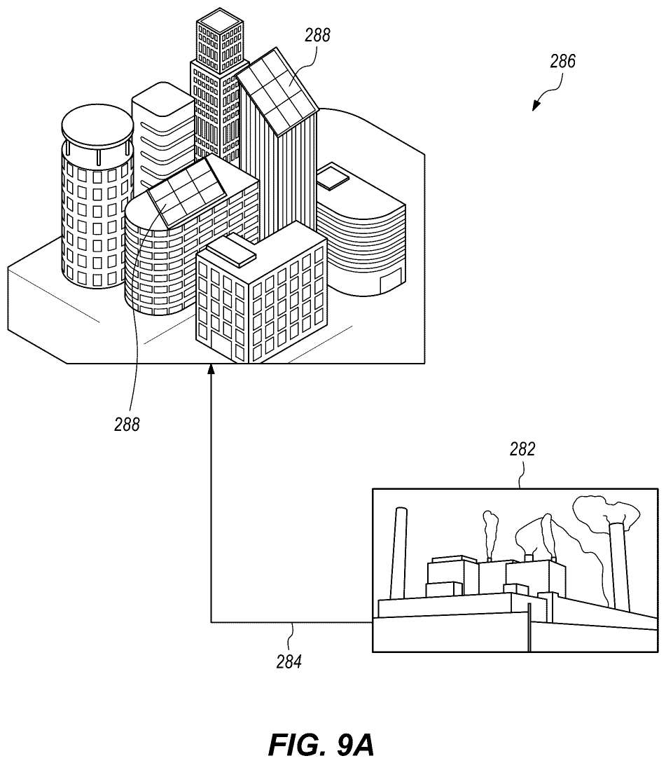

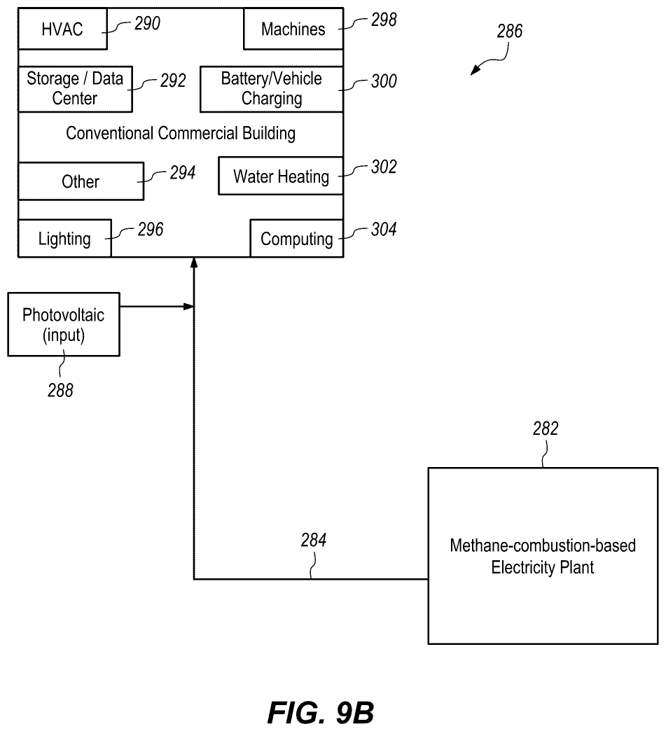

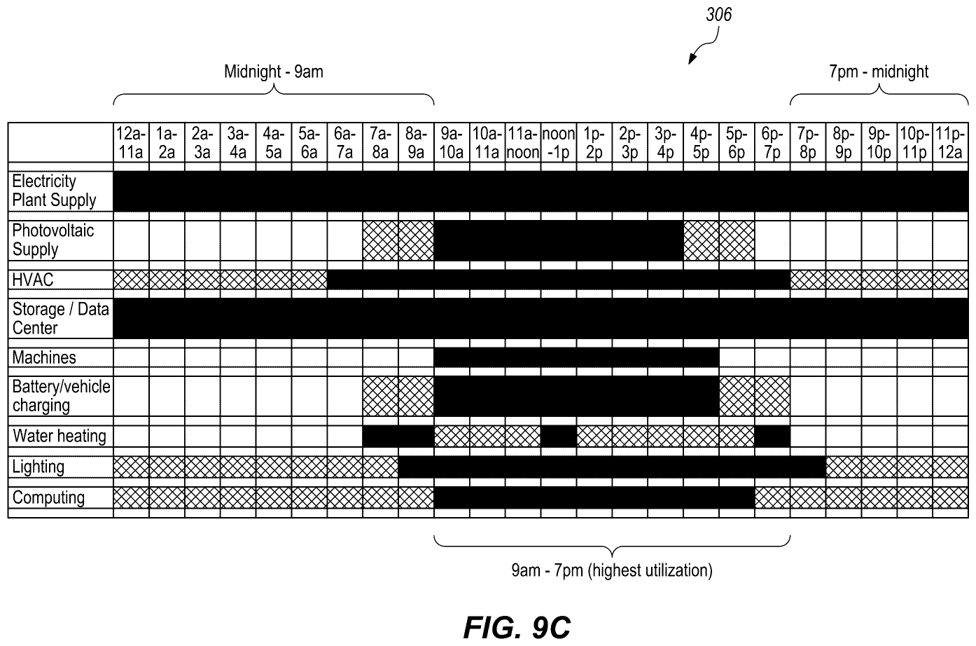

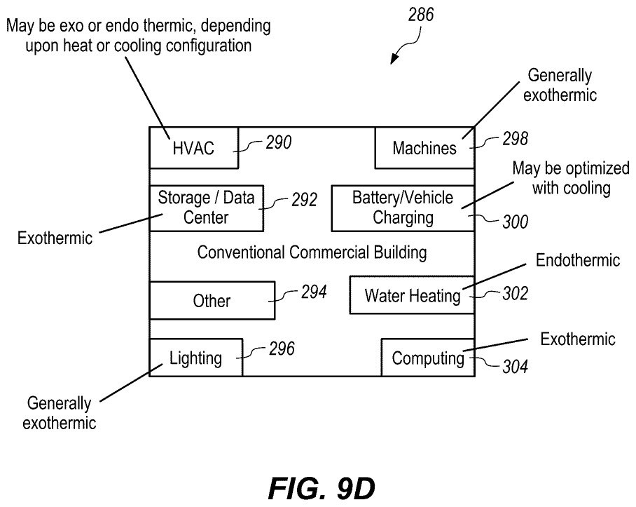

Referring to FIG. 9A, a conventional configuration is illustrated, wherein a remotely-located power plant (282), such as one configured to combust methane in the process of producing electricity, may be configured to deliver, by conducting powerline (284), electricity to a campus or assembly of buildings (286). The campus also may feature, for example, various photovoltaic solar panels (288) configured to augment the energy supply of the campus. FIG. 9B illustrates such a configuration in schematic form, with the power plant (282) providing electricity along with the photovoltaic sources (288) to the building campus (286). Further illustrated in the schematic are various operations which may consume power. For example, the illustrated building schematic includes an HVAC system (290), an electronic storage/data-center (292), certain machines (298), battery and/or vehicle charging facilities (300), water heating systems (302), computing systems (304), lighting systems (296), and other (294) energy-consuming systems. FIG. 9C illustrates a sample utilization schedule (306) to show that various elements in a typical building or campus configuration end up requiring utilization at different times throughout the day, so there is a time-domain relevance to the way that energy/power is routed around the campus or building. Referring to FIG. 9D, various elements from the configuration of FIG. 9B are illustrated to point out which elements may require and/or develop heat, for example. As shown in FIG. 9D, for example, HVAC may consume or produce heat in various amounts, depending upon the operational mode (heating or air conditioning); machines, such as robots, printers, elevators, and the like, generally produce heat during operation; storage/data centers generally produce heat; battery/vehicle charging may produce small amounts of heat, and may be operationally optimized with cooling if available; water heating generally consumes heat; computing generally produces heat; and lighting generally produces heat. Given the time-domain challenges of optimizing efficiency of these resources, as well as the complexity of the different functional elements, a computing-based solution may be utilized for efficiency optimization utilizing the thermal transfer configurations described here.

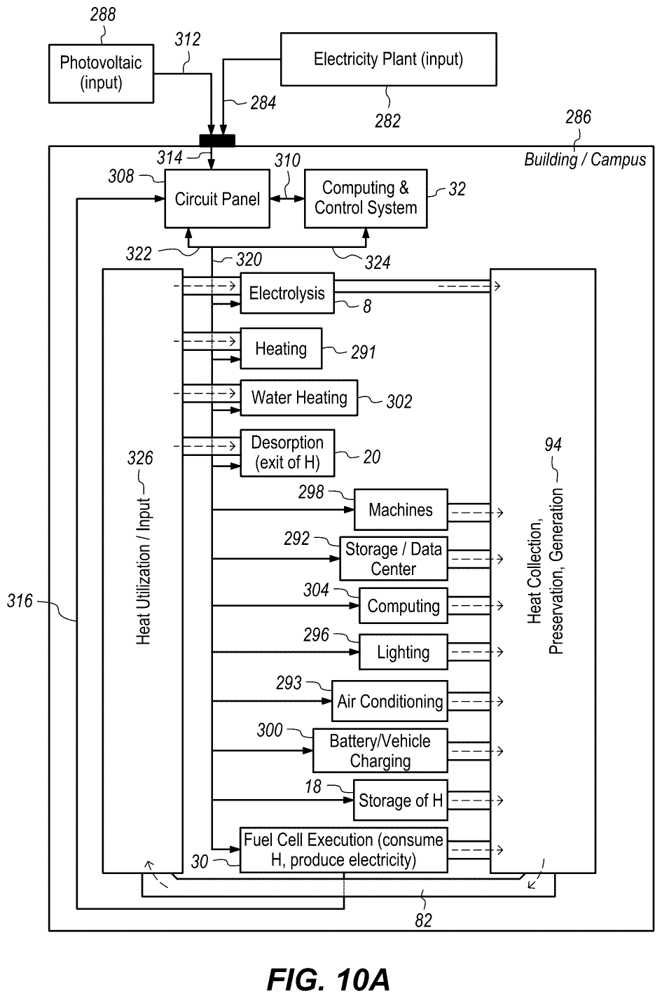

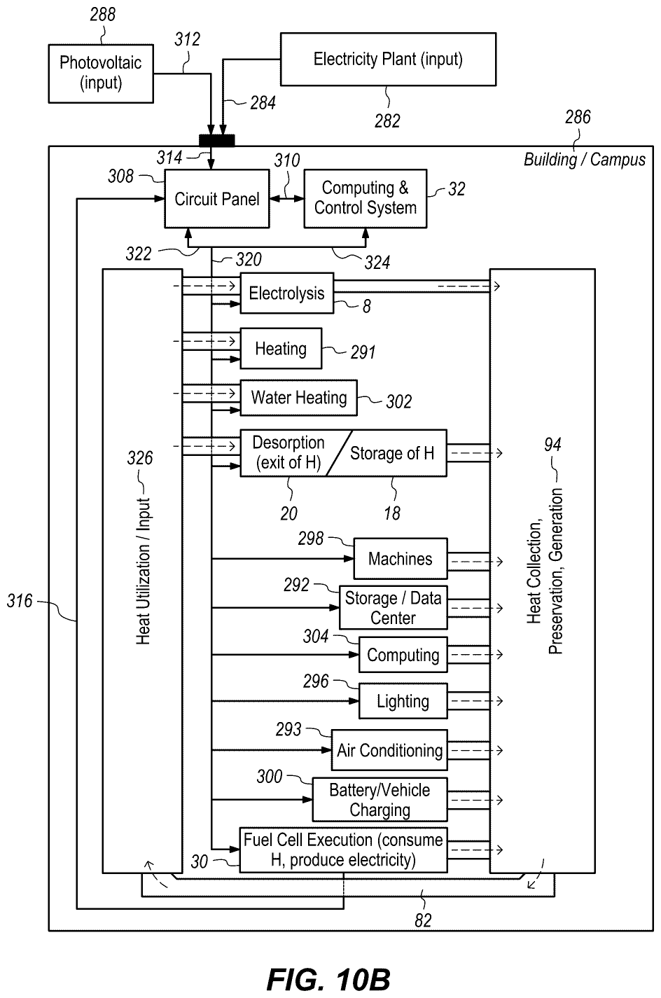

For example, referring to FIG. 10A, an efficiency optimization system is illustrated showing controlled thermal transfers through at network of thermal transfer conduits and reservoirs pertaining to a campus, building, or portion thereof which may be operatively coupled (284, 312, respectively) to an external power plant (282) and a photovoltaic energy source (288) using coupling (314) to a circuit panel (308) which may be operatively coupled to a computing and control system (32), which may be operatively coupled to one or more operator or user systems (not shown) for visualization, supervision, and control purposes. Each functional element is shown between a heat collection, preservation, and generation reservoir (94) and an interconnected (via conduit 82, for example) heat utilization/input reservoir or enclosure (326), and each may be operatively coupled (320, 322, 324; or wireless connectivity as described above), such as by local control node, local controller, and/or direct connection to the main circuit panel (308) and/or computing and control system (32). Thus the electrolysis (8) process may be controllably input with warm heat transfer fluid to facilitate efficient electrolysis processing, and waste heat may be conserved and output to the heat collection reservoir (94); building heating (291) may be supplemented on the input side; water heating (302) may be supplemented on the input side; desorption (exit or hydrogen from storage; 20) may be heated on the input side; machines (298) may be configured to exit heat to the reservoir (94); digital storage/data center systems (292) may be configured to exit heat to the reservoir (94); computing resources (304) may be configured to exit heat to the reservoir (94); lighting system (296) may be configured to exit heat to the reservoir (94); air conditioning components (293) may be configured to exit heat to the reservoir (94); battery/vehicle charging components (300) may be configured to exit heat to the reservoir (94); storage mode metal hydride configuration (18) may be configured to exit heat to the reservoir (94); and fuel cell execution or operation (30) may be configured to exit heat to the reservoir (94), for example, and to send produced electricity to the main circuit panel (308) via conductive connection (316). FIG. 10B illustrates a configuration similar to that of FIG. 10A, with the exception that the metal hydride storage/desorption modules (18/20) have been combined as they may involve different functional aspects of the same elements, for illustrative purposes.

Referring to FIG. 11A, with regard to robust structures capable of handling heightened pressures and temperatures for purposes of, for example, an activated metal hydride hydrogen storage or desorption vessel, various cylinder type structures may be utilized, typically with in/out (“I/O”) engagement interfacing at one end, somewhat akin to a conventional pressurized fluid tank (328) like those utilized in the diving or beverage industries (which typically have a valved I/O interface 329 at one end, as shown; such vessels typically are made of aluminum, which may not be suitable for activated metal hydride hydrogen storage or desorption vessel usage, due to factors including hydrogen-based embrittlement, general strength factors, etc). Referring to FIG. 11B, a suitable activated metal hydride hydrogen storage or desorption vessel is illustrated (330) comprising a high-strength material resistant to hydrogen embrittlement, such as 316 stainless steel. The vessel assembly (330) may, for example, comprise a generally cylindrical body portion (336), an end portion (334) bolted in place against the body portion (336) with a plurality of heavy duty fasteners (342) to define an interior volume (340) also encapsulated by top portion (338; also may be fixedly held in place relative to the body portion 336 using fasteners 343). The top portion (338) may define one or more apertures therethrough, through which one or more I/O structures may be positioned, such as an I/O interface member (344) which may be configured to accommodate structures such as thermocouples, flow tubes or pipes, pressure valves, filling devices or structures, and the like (the configuration of FIG. 11C shows a valve assembly 346 positioned across the I/O interface member 344 to provide controlled and sealable access to the interior volume 340).

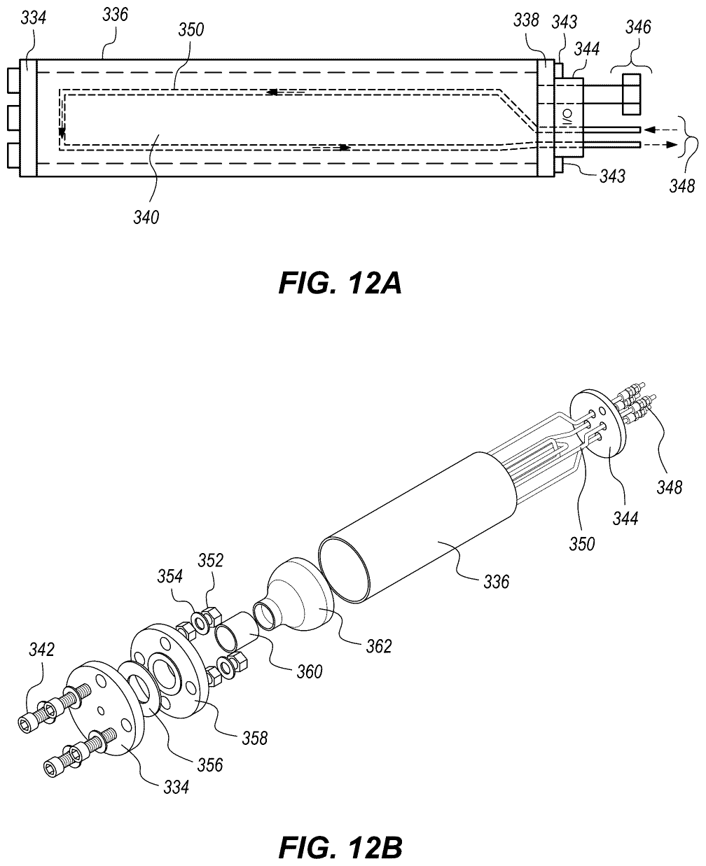

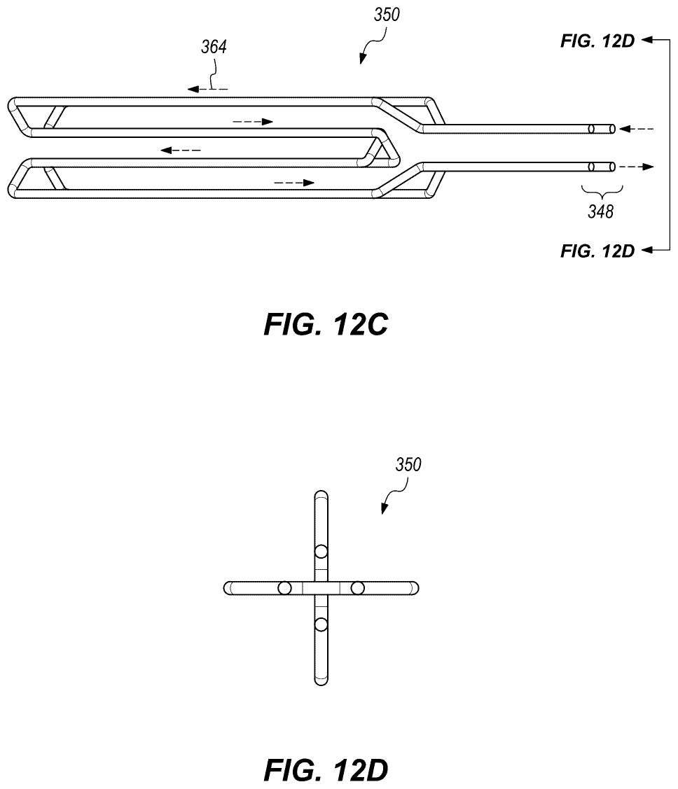

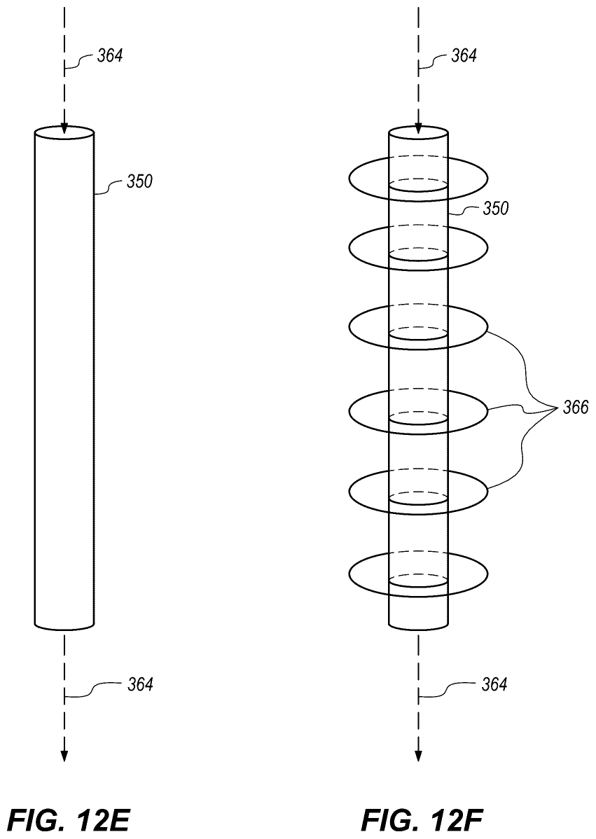

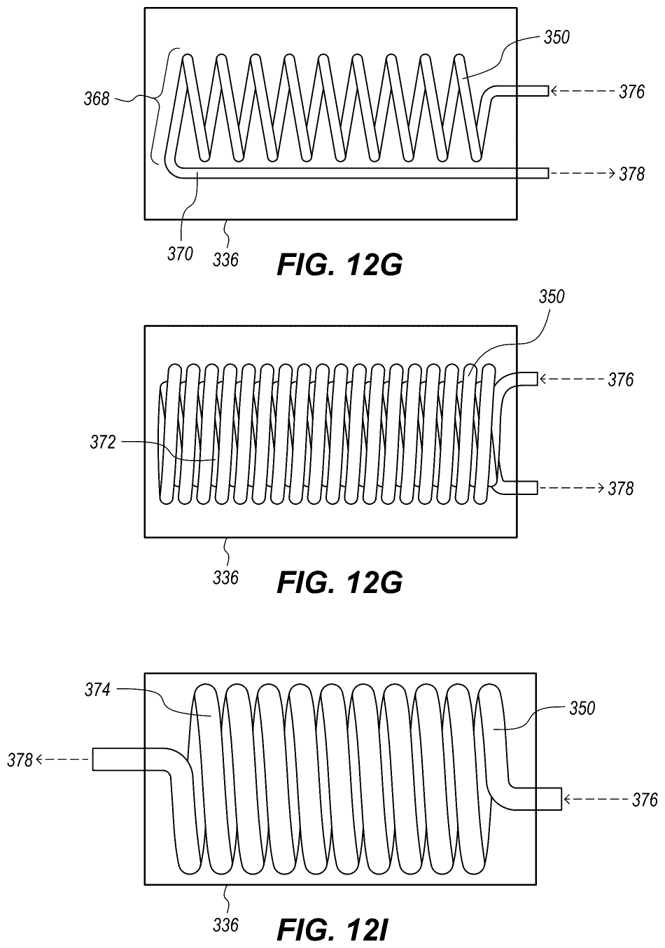

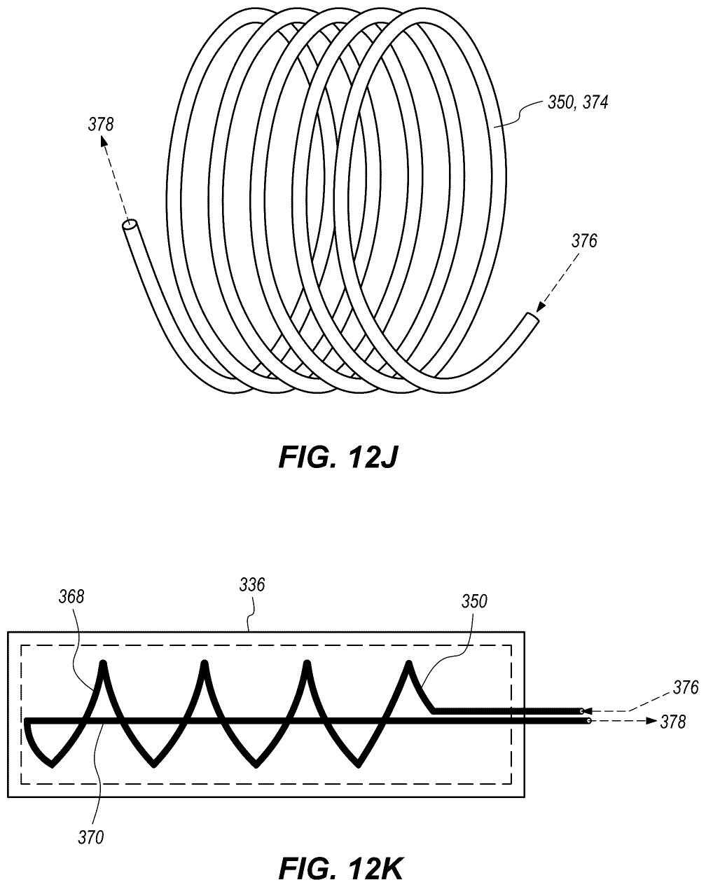

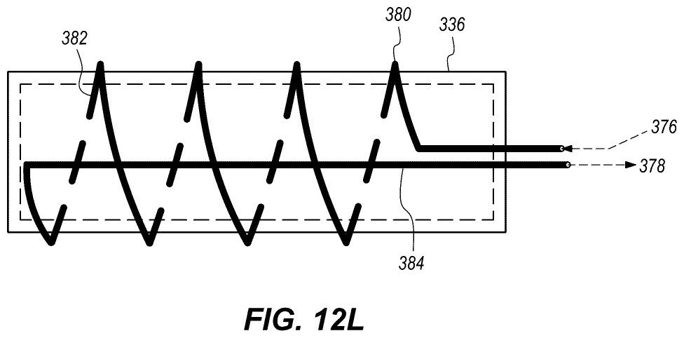

Referring to FIG. 12A, a configuration similar to that of FIG. 11C is illustrated, the configuration of FIG. 12A also featuring an indwelling flow tubing circuit (350) configured to facilitate directional flow (348) into the interior volume (340) and back out, while pressure and seal are maintained for the interior volume (340). Such a flow circuit (350) may be utilized, for example, for circulating thermal energy transfer fluid, such as water or other thermal transfer fluid material, for example to remove heat or add heat from the interior volume and material therein. Indeed, referring to FIGS. 12B, 12C, and 12D, several views of an embodiment of a vessel (330) configuration with thermal energy transfer fluid circuit (350) are illustrated. The exploded view of FIG. 12B illustrates an end portion (334) which may be coupled to a body portion (336) using fasteners (342); several other structures (oil-resistant compressible basket structure 356; unthreaded high-pressure flange member 358; connecting pipe member 360; concentric reducer member 362) may be fixedly coupled to the end portion (334) and body portion (336) using the fasteners and additional washer members (354) and fastener components (352, such as bolts). As shown in FIGS. 12B and 12C, the thermal energy transfer fluid circuit (350) may comprise four elongate portions coupled centrally to provide relatively large exposure to the geometric extents of the interior volume (340). In other words, such a geometry may be utilized to facilitate broad exposure of materials within the interior volume to thermal energy transfer fluids which may be flowed (364) through the thermal energy transfer fluid circuit (350) from outside of the vessel (330). The embodiment depicted in FIG. 12C, for example, has parallel (i.e., a plural pathway of flow as shown, as opposed to a unitary pathway through a single tubular pathway in other embodiments, such as in the embodiment of FIG. 12G, for example) elongate, or substantially straight, pathways with shorter arcuate couplings.

Referring to FIG. 12E, tubular portions of the thermal energy transfer fluid circuit (350) may comprise relatively straight cylindrical pipe geometries to accommodate flow (364) therethrough and associated thermal energy transform, or may feature surface expansion structures (366) to enhance thermal transfer to nearby materials, as shown, for example, in FIG. 12F. Referring to FIGS. 12G, 12H, and 12I, various configurations for thermal energy transfer fluid circuit (350) structures are illustrated along with flow I/O (376, 378) from outside of the body structures (336). For example, referring to FIG. 12G, in one embodiment the thermal energy transfer fluid circuit (350) may comprise a helical portion (368) coupled with an elongate return portion (370). Referring to the variation of FIG. 12H, the thermal energy transfer fluid circuit (350) may comprise a double helical configuration (372) with helical pathways for flow in both directions. Referring to the variation of FIG. 12I, a simple helical configuration (374) without return, but rather with exit at the other end may be utilized; FIG. 12J illustrates an orthogonal view of a simple helical configuration (374) of a thermal energy transfer fluid circuit (350) similar to that of FIG. 12I.

Referring to FIG. 12K, again, thermal energy transfer fluid, such as water or other material, may be circulated (376, 376) through the interior volume defined by the body structure (336), end portion (334), and top portion (338), such as via a helical pathway (368) combined with an elongate pathway (370).

Referring to FIG. 12L, an external thermal energy transfer fluid circuit (380) may be coupled to the outside of the body structure (336) to transfer thermal energy to the vessel as well as to materials therein, rather than having an indwelling thermal energy transfer fluid circuit (350; i.e., rather than having the circuit go into the interior of the body structure 336). This FIG. 12L features a helical portion (382) wrapped around the body structure (336) along with an elongate (384) return path following externally along one side of the body structure (336).

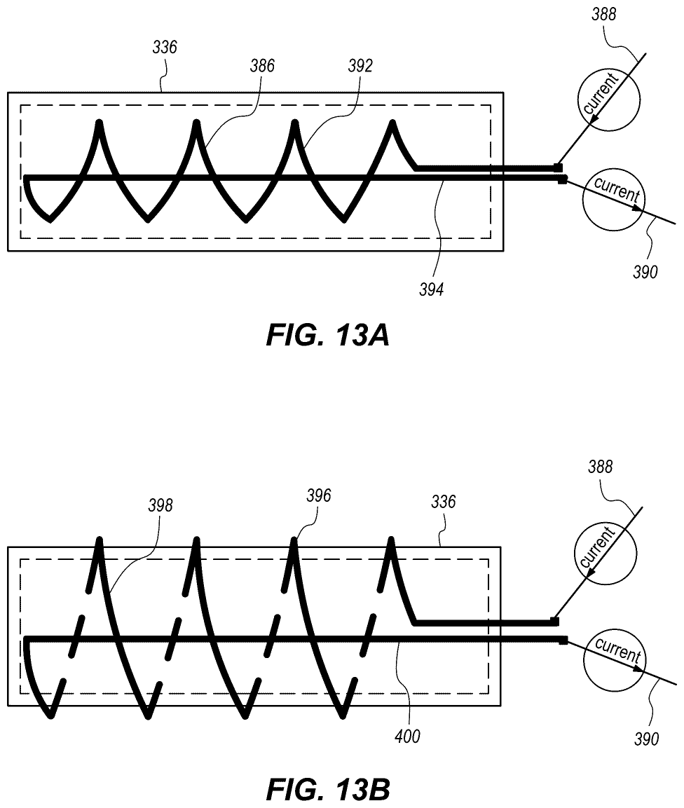

Referring to FIG. 13A, flowing current (388, 390) through a heating element may also provide for controlled heating within a vessel. FIG. 13A illustrates a partially helical (392) and partially elongate (394) current-based interior heating element (386). Referring to FIG. 13B, an external current-based heating element (396) may be utilized for controlled heating of the body structure (336) and materials therein or coupled thereto, the external current-based heating element (396) depicted in FIG. 13B comprising a helical portion (398) and an elongate portion (400).

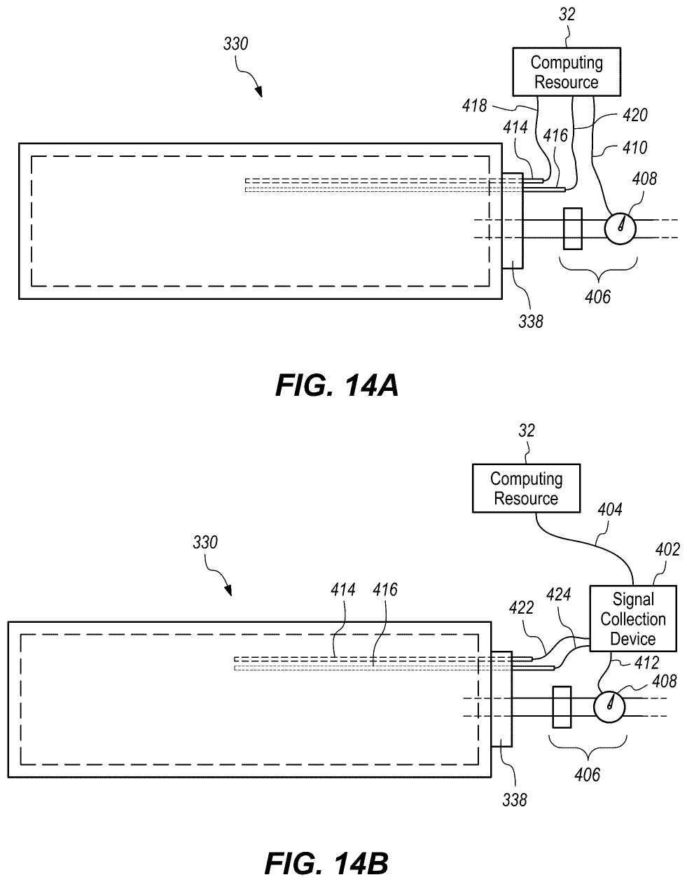

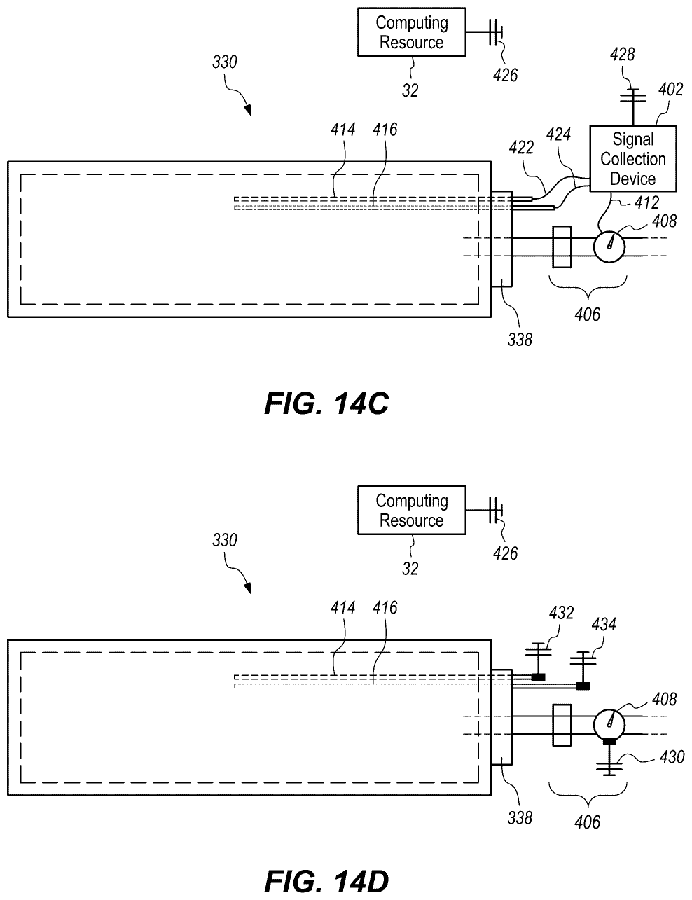

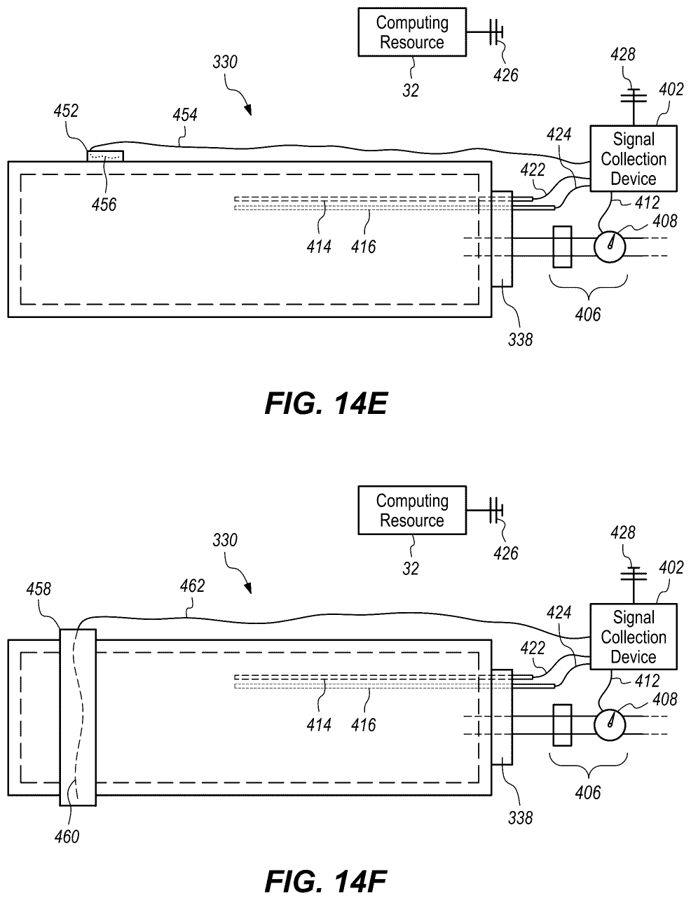

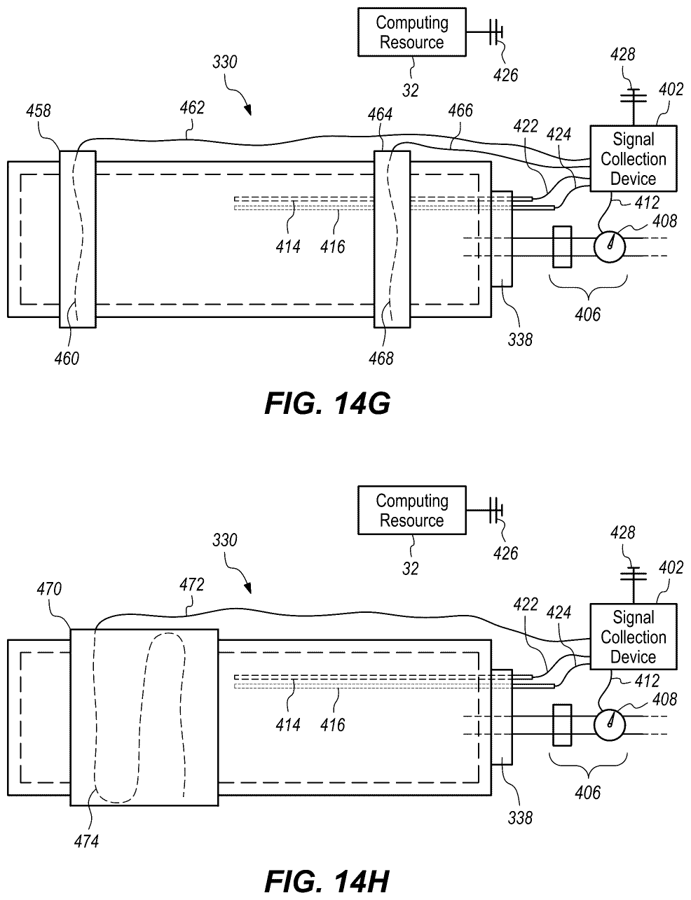

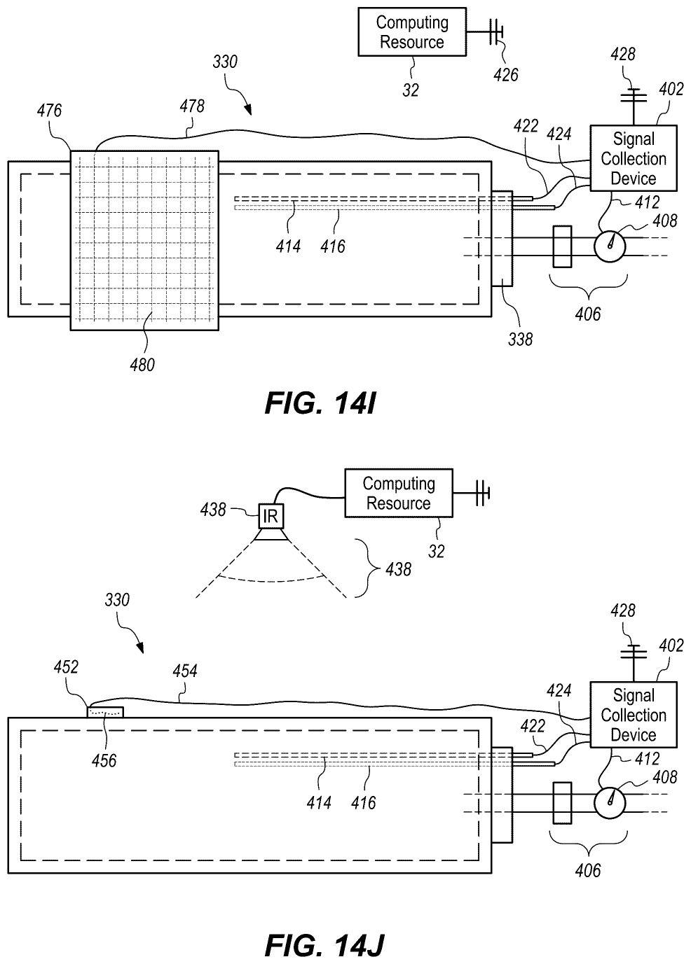

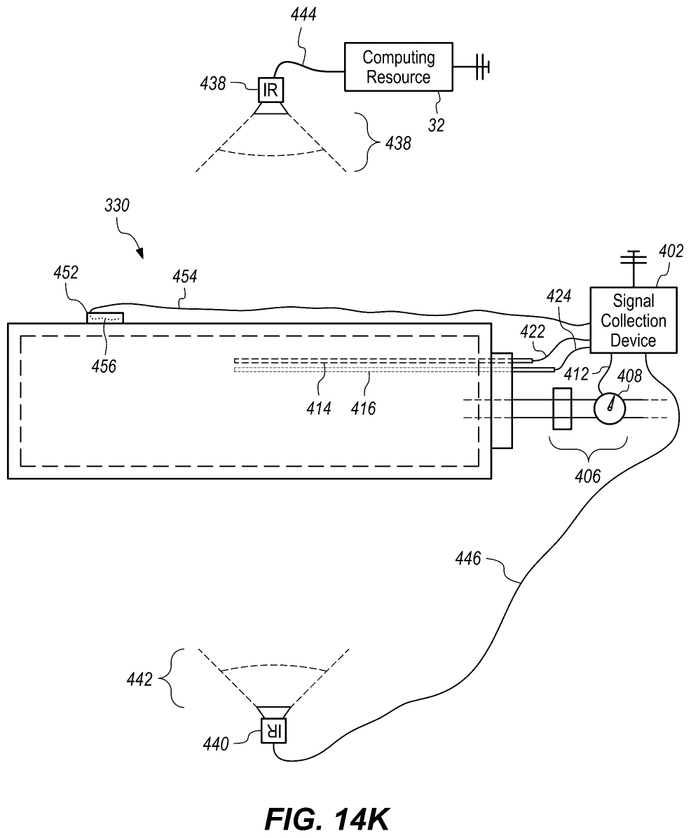

Referring to FIG. 14A, as noted above, various elements may be operatively coupled to one or more computing systems or resources via physical wiring, as shown in the illustrated embodiment wherein a computing resource (32) is operatively coupled (410) to a pressure sensor (408) coupled to an I/O interface (406); the computing resource (32) also is operatively coupled (418, 420) to two indwelling structures (414, 416, respectively), which may represent sensors or control devices of various types; for example, the first (414) may comprise an indwelling thermocouple, and the second (416) may comprise an indwelling resistive heating element or pressure sensor. Referring to FIG. 14B, an embodiment similar to that of FIG. 14A is illustrated, with the embodiment of FIG. 14B comprising a separate signal collection device (402), such as a small microcontroller, amplifier, signal processor, or other electronic device which may reside at a local node near the particular I/O area of the particular vessel. The first and second indwelling devices (414, 416) may be configured, for example, to couple directly (422, 424) to the signal collection device (402), which may then be coupled (404) to the computing system (32).

Referring to the embodiments of FIGS. 14C-14K, for example, various portions of the system may be operatively coupled using wireless communication configurations (such as IEEE 801.11 type connectivity, so-called “nearfield” radiofrequency connectivity, radiofrequency connectivity that utilizes the Bluetooth™ standards, etc). For example, referring to FIG. 14C, the depicted signal collection device (402) may be wirelessly (428, 426) operatively coupled with the computing system (32) to share signals and information. Referring to FIG. 14D, the three depicted sensor elements (414, 416, 408) may be wirelessly (432, 434, 430) operatively coupled with the computing system (32) to share signals and information.

Referring to FIGS. 14E-14K, various geometries and configurations of heating elements may be coupled to portions of vessel (330) configurations to provide thermal control. For example, referring to FIG. 14E, a relatively small and discrete heating element (452) may be coupled (such as by an adhesive, fastener, belt, magnet, or the like) to the outer surface of the vessel (330) to provide controlled heating through a discrete contact area with the vessel (330). The discrete heating element (452) may comprise a current-based or resistive heating element (456) therein which responds to input current to provide localized heating, for example. The resistive heating element (456) may be operatively coupled to the signal collection device (402) and/or computing system (32) for precision control and monitoring. Referring to FIG. 14F, a configuration similar to that of FIG. 14E is illustrated, with a larger surface area perimetric heating cuff element (458) comprising a heating element (460) which may be utilized to controllably heat coupled materials, including the vessel (330) and materials therein. The heating element (460) may be operatively coupled (462) to the signal collection device (402) and/or computing system (32) for precision control and monitoring. Referring to FIG. 14G, a configuration featuring a plurality of perimetric heating cuff elements (458, 464), each featuring a heating element (460, 468) which may be coupled (462, 466) to the signal collection device (402) and/or computing system (32) for independent and precise control and monitoring. FIG. 14H illustrates a configuration with a substantially wide perimetric heating cuff element (470) featuring a patterned heating element (474) which is operatively coupled (472) to the signal collection device (402) and/or computing system (32) for precision control and monitoring.

FIG. 14I illustrates a configuration with a substantially wide perimetric heating cuff element (476) featuring a matrix heating element (480) which is operatively coupled (478) to the signal collection device (402) and/or computing system (32) for precision control and monitoring. It may be desirable in various configurations to have larger surface area heating and control contact, such as in the embodiments of FIGS. 14H and 14I; alternatively it may be desirable in certain embodiments to have more discrete contact areas, such as in the embodiments of FIGS. 14E-14G.

Referring to FIGS. 14J and 14K, while thermocouples may be utilized to monitor various temperatures of various elements within the subject systems, infrared imaging devices may also be utilized for temperature monitoring, and may be particular useful when utilized to monitor an array or adjacently positioned vessels, for example in a rack or storage matrix configuration. Referring to FIG. 14J, an infrared imaging or sensing device (438) has a field of view or field of capture (438) that is oriented toward a vessel (330) so that it may be utilized to monitor surface temperatures pertaining to the vessel (330) and associated structures, such as via operative coupling to a computing system (32). Referring to FIG. 14K, for additional monitoring, additional field of capture, or generally further information, a plurality of infrared imaging or sensing devices (438, 440) may be utilized, here each having different fields of capture or fields of view (438 generally opposing 442); this embodiment shows one IR device (438) proximally positioned adjacent the computing system (32) to be directly operatively coupled (i.e., as with a control connector cable 444), while the more distant IR device (440) may be operatively coupled back to the computing system (32) in a variety of ways, such as via direct operative coupling (i.e., by control connector cable 446) back to an intermediate device such as the signal collection device (402), which may be wirelessly operatively coupled to the computing resource (32).

Referring to FIG. 15A, a metal hydride storage and/or desorption vessel assembly (482), such as that described in reference to FIG. 14B, for example, may be operatively coupled to a fire extinguishment system (486, such as a controlled Halon distribution system) to provide for quick and controlled fire retardation in the event of any unexpected issues. Such a metal hydride storage and/or desorption vessel assembly (482) may be duplicated or scaled as shown (such as in a stable rack assembly 484) to provide a storage assembly with heightened capacity in the aggregate. In various embodiments, sensors such as infrared devices may be operatively coupled to such rack (484) assemblies or mounted nearby for thermal monitoring. Referring to FIG. 15B, further scale may be provided with rack assemblies (484, 485) such as that shown wherein a cubic or prismic overall structure may be utilized to contain a relative large number of metal hydride storage and/or desorption vessel assemblies (482). Indeed, referring to FIG. 15C, storage may be aggregated within rooms, buildings, and other enclosures to provide for enhanced scale; with or without such scale, it may be desirable to provide nearby computing resource (32, 488, 492) and connectivity (426, 490, 494) redundancy and/or scale.

Referring to FIGS. 16A-20C, various process-related configurations are illustrated.

Referring to FIG. 16A, an electrolysis system or subsystem may be ready to operate with temperature-controlled water and electricity input (502). A computing system may be operatively coupled to one or more temperature sensors, one or more water input flow indicators, and one or more flow control devices (504). The computing system may be configured to operate the electrolysis subsystem under closed-loop control paradigm dynamic to one or more sensed variables (such as input water temperature, water input flow, and/or flow of water, output oxygen, or output hydrogen) (506). The computing system may be configured to at least temporarily stop the electrolysis subsystem in the event that one of the one or more sensed variables is determined to be outside of a pre-prescribed range for normal operation (508). The electrolysis subsystem may be configured to controllably output hydrogen gas, oxygen gas, and warmed water, each of which may be monitored using the operatively-coupled computing system (510).

Referring to FIG. 16B, an electrolysis system or subsystem may be ready to operate with temperature-controlled water and electricity input (502). A computing system may be operatively coupled to one or more temperature sensors, one or more water input flow indicators, and one or more flow control devices (504). The computing system may be configured to operate the electrolysis subsystem under closed-loop control paradigm dynamic to one or more sensed variables (such as input water temperature, water input flow, and/or flow of water, output oxygen, or output hydrogen) (506). The computing system may be configured to at least temporarily stop the electrolysis subsystem in the event that one of the one or more sensed variables is determined to be outside of a pre-prescribed range for normal operation (508). The electrolysis subsystem may be configured to controllably output hydrogen gas, oxygen gas, and warmed water, each of which may be monitored using the operatively-coupled computing system (510). The electrolysis subsystem may comprise a heat re-capture module configured to transfer heat away from the products of electrolysis (hydrogen gas, oxygen gas, water) (512).

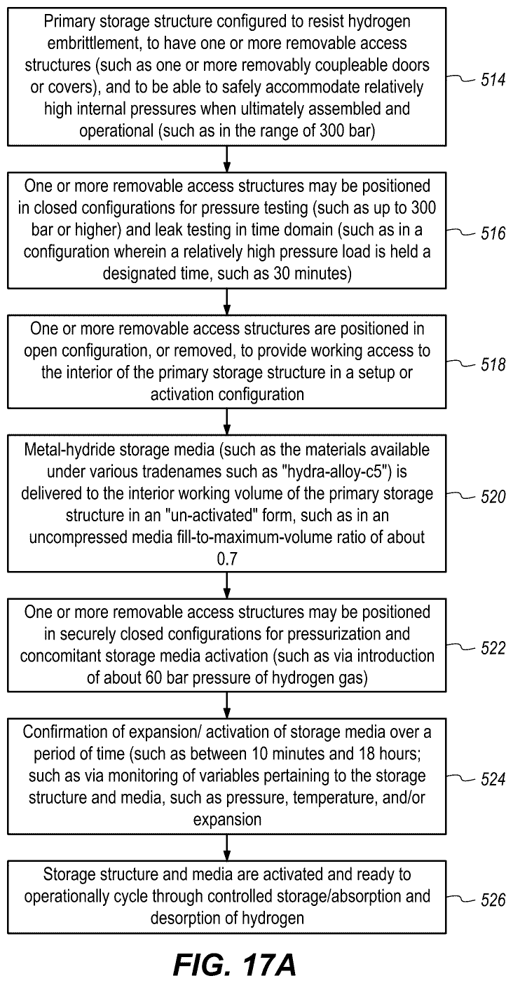

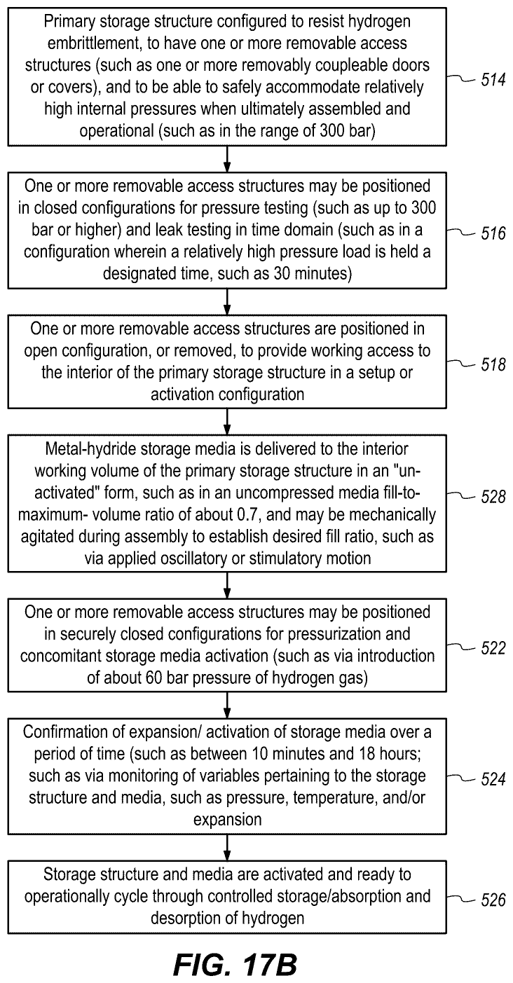

Referring to FIG. 17A, a primary storage structure, such as a vessel, may be configured to resist hydrogen embrittlement, to have one or more removable access structures (such as one or more removably coupleable doors or covers), and to be able to safely accommodate relatively high internal pressures when ultimately assembled and operational (such as in the range of 300 bar) (514). One or more removable access structures (such as end and front or top portions configured to be engageably coupled to a central body structure) may be positioned in closed configurations for pressure testing (such as up to 300 bar or higher) and leak testing in time domain (such as in a configuration wherein a relatively high pressure load is held a designated time, such as 30 minutes) (516). The one or more removable access structures may be positioned in an open configuration, or removed, to provide working access to the interior of the primary storage structure in a setup or activation configuration (518). Metal-hydride storage media (such as the materials available under various tradenames such as “hydra-alloy-c5” or “hydralloy c5”; may comprise a titanium metal hydride comprises hydralloy C5 with a stoichiometry configuration of about Ti 0.95 Zr 0.05 Mn 1.46 V 0.45 Fe 0.09; this is known or classified as a type AB2 metal hydride) may be delivered to the interior working volume of the primary storage structure in an “un-activated” form, such as in an uncompressed media fill-to-maximum-volume ratio of about 0.7 (520). The one or more removable access structures may be positioned in securely closed configurations for pressurization and concomitant storage media activation (such as via introduction of about 60 bar pressure of hydrogen gas; this activation may be conducted in situ; i.e., using the particular vessel that will contain the particular media) (522). Expansion/activation of the storage media over a period of time (such as between 10 minutes and 18 hours) may be confirmed, such as via monitoring of variables pertaining to the storage structure and media, such as pressure, temperature, and/or expansion (524). The storage structure and media may be activated and ready to operationally cycle through controlled storage/absorption and desorption of hydrogen (526).

In another embodiment, a titanium metal hydride called “ferrotitanium” (or FeTi; classified as a type AB metal hydride) may be utilized in the storage module as storage media; such a configuration may be activated with a 60 bar pressurization of hydrogen gas as noted above for hydralloy c5, but with ferrotitanium heating of up to about 400 degrees C. may be utilized also for activation (and as noted above, the activation of the storage media may be conducted in situ, in the particular vessel to be utilized with the storage media).

In various embodiments, additives such as graphite powder may be mixed into the metal oxide storage compound to make the overall mixture more porous and assist with compaction with in the vessel (330). Such a configuration may be utilized also to generally improve thermal conductivity of the storage media to better transfer and move heat. In various embodiments, the storage media may be compressed, or partially compressed, before it is placed into the vessel (330). For example, in various embodiments the storage media may be compressed into one or more pellets which may be various geometries, such as cubics, rectangular prisms, cylinders, and the like. In certain embodiments, it may be desirable to place pre-compressed storage media pellets for constructs into the vessel (330) which relate to the available geometry of the interior volume (340). For example, if the interior volume is generally cylindrical, but partially occupied by a helical thermal transfer circuit (350), it may be desirable to insert a pre-prepared compressed media construct which fits into the center volume defined by the helical thermal transfer circuit, and then to fit elongate sliver-like pellets or constructs between the outer aspects of the helical thermal transfer circuit and the inner wall of the cylindrical body member (336). In other words, given an expected geometric configuration pertaining to the working volume or interior volume of the storage setup, compressed pellets or constructs may be prepared to optimize based upon this expected geometric configuration.

Referring to FIG. 17B, a primary storage structure, such as a vessel, may be configured to resist hydrogen embrittlement, to have one or more removable access structures (such as one or more removably coupleable doors or covers), and to be able to safely accommodate relatively high internal pressures when ultimately assembled and operational (such as in the range of 300 bar) (514). One or more removable access structures (such as end and front or top portions configured to be engageably coupled to a central body structure) may be positioned in closed configurations for pressure testing (such as up to 300 bar or higher) and leak testing in time domain (such as in a configuration wherein a relatively high pressure load is held a designated time, such as 30 minutes) (516). The one or more removable access structures may be positioned in an open configuration, or removed, to provide working access to the interior of the primary storage structure in a setup or activation configuration (518). Metal-hydride storage media may be delivered to the interior working volume of the primary storage structure in an “un-activated” form, such as in an uncompressed media fill-to-maximum-volume ratio of about 0.7, and may be mechanically agitated during assembly to establish desired fill ratio, such as via applied oscillatory or stimulatory motion (528). For example, an applied vibratory or oscillatory motion or vibration may be utilized to assist in loading, distributing, and/or settling the storage media. The one or more removable access structures may be positioned in securely closed configurations for pressurization and concomitant storage media activation (such as via introduction of about 60 bar pressure of hydrogen gas) (522). Expansion/activation of the storage media over a period of time (such as between 10 minutes and 18 hours) may be confirmed, such as via monitoring of variables pertaining to the storage structure and media, such as pressure, temperature, and/or expansion (524). The storage structure and media may be activated and ready to operationally cycle through controlled storage/absorption and desorption of hydrogen (526).

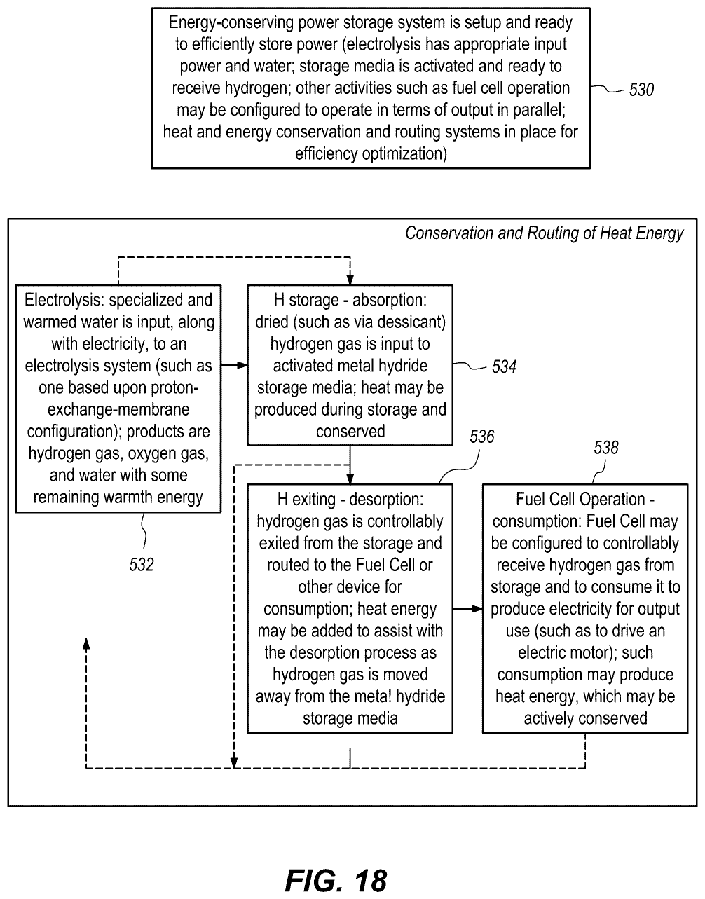

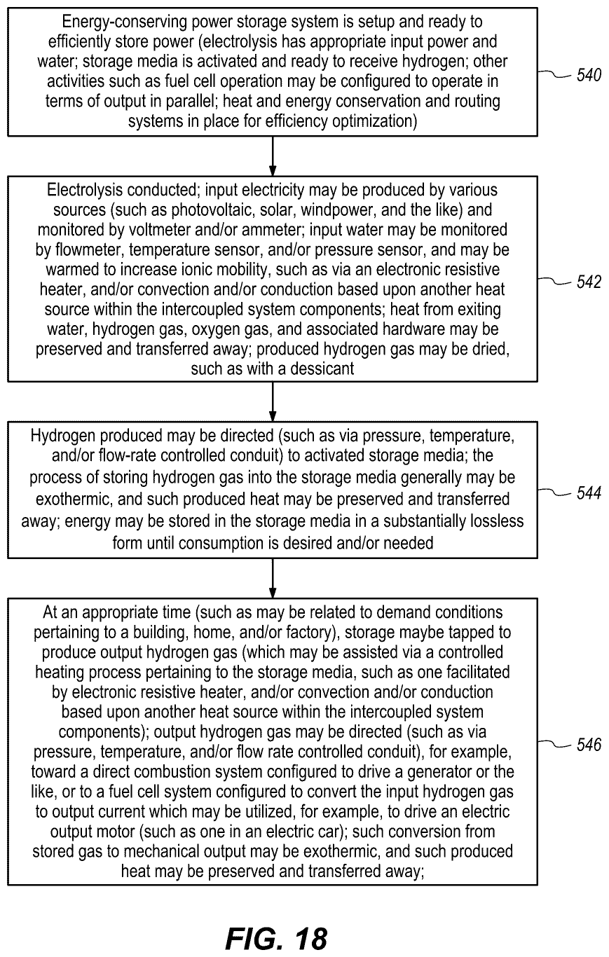

Referring to FIG. 18, an energy-conserving power storage system may be setup and ready to efficiently store power (electrolysis has appropriate input power and water; storage media may be activated and ready to receive hydrogen; other activities such as fuel cell operation may be configured to operate in terms of output in parallel; heat and energy conservation and routing systems may be in place for efficiency optimization) (530). As shown in FIG. 18, electrolysis may be conducted, wherein specialized and warmed water is input, along with electricity, to an electrolysis system (such as one based upon proton-exchange-membrane configuration); products are hydrogen gas, oxygen gas, and water with some remaining warmth energy (532); resultant hydrogen may be stored by absorption: it may be dried (such as via dessicant) and input to the activated metal hydride storage media; heat may be produced during storage and conserved (534). With controlled desorption, hydrogen gas may be controllably exited from the storage and routed, for example, to a fuel cell or other device for consumption; heat energy may be added to assist with the desorption process as hydrogen gas is moved away from the metal hydride storage media (536). With fuel cell operation (538), the fuel cell may be configured to controllably receive hydrogen gas from storage and to consume it to produce electricity for output use (such as to drive an electric motor); such consumption may produce heat energy, which may be actively conserved.

Referring to FIG. 19, an energy-conserving power storage system may be setup and ready to efficiently store power (electrolysis has appropriate input power and water; storage media is activated and ready to receive hydrogen; other activities such as fuel cell operation may be configured to operate in terms of output in parallel; heat and energy conservation and routing systems in place for efficiency optimization) (540). Electrolysis may be conducted, with input electricity being produced by various sources (such as photovoltaic, solar, windpower, and the like) and monitored by voltmeter and/or ammeter; input water may be monitored by flowmeter, temperature sensor, and/or pressure sensor, and may be warmed to increase ionic mobility, such as via an electronic resistive heater, and/or convection and/or conduction based upon another heat source within the intercoupled system components; heat from exiting water, hydrogen gas, oxygen gas, and associated hardware may be preserved and transferred away; produced hydrogen gas may be dried, such as with a dessicant (542). Hydrogen may be produced and may be directed (such as via pressure, temperature, and/or flow-rate controlled conduit) to activated storage media; the process of storing hydrogen gas into the storage media generally may be exothermic, and such produced heat may be preserved and transferred away; energy may be stored in the storage media in a substantially loss-less form until consumption is desired and/or needed (544). At an appropriate time (such as may be related to demand conditions pertaining to a building, home, and/or factory), storage may be tapped to produce output hydrogen gas (which may be assisted via a controlled heating process pertaining to the storage media, such as one facilitated by electronic resistive heater, and/or convection and/or conduction based upon another heat source within the intercoupled system components); output hydrogen gas may be directed (such as via pressure, temperature, and/or flow rate controlled conduit), for example, toward a direct combustion system configured to drive a generator or the like, or to a fuel cell system configured to convert the input hydrogen gas to output current which may be utilized, for example, to drive an electric output motor (such as one in an electric car); such conversion from stored gas to mechanical output may be exothermic, and such produced heat may be preserved and transferred away (546).

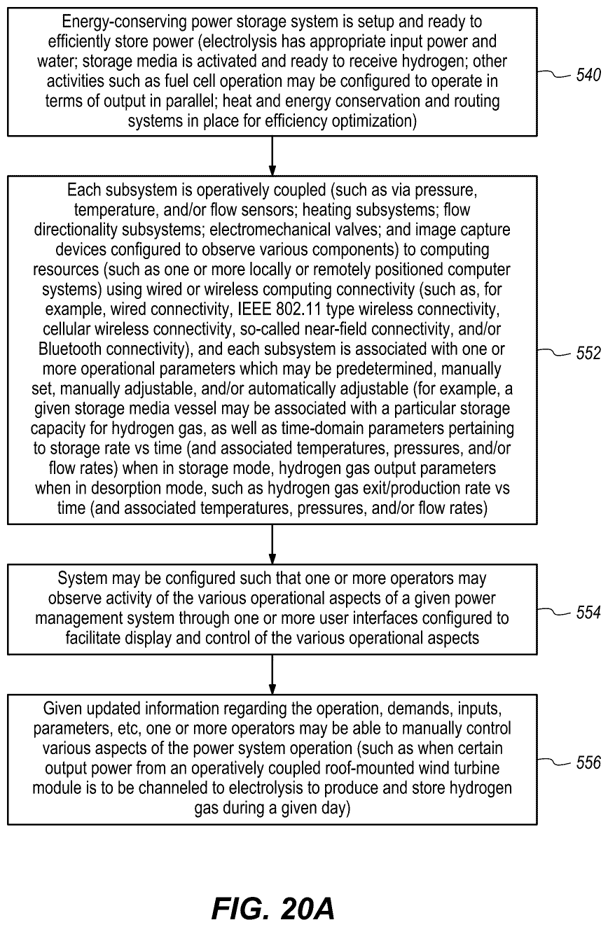

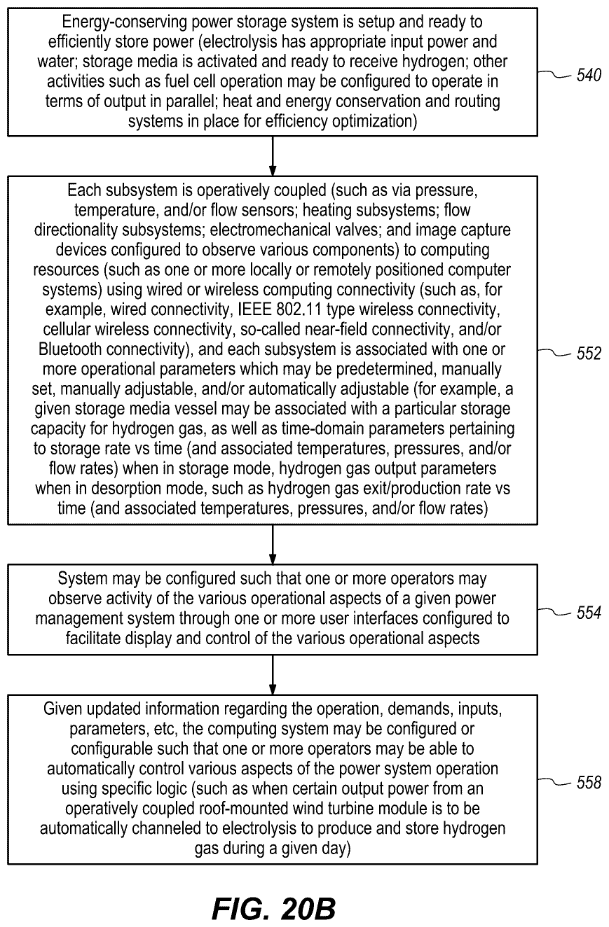

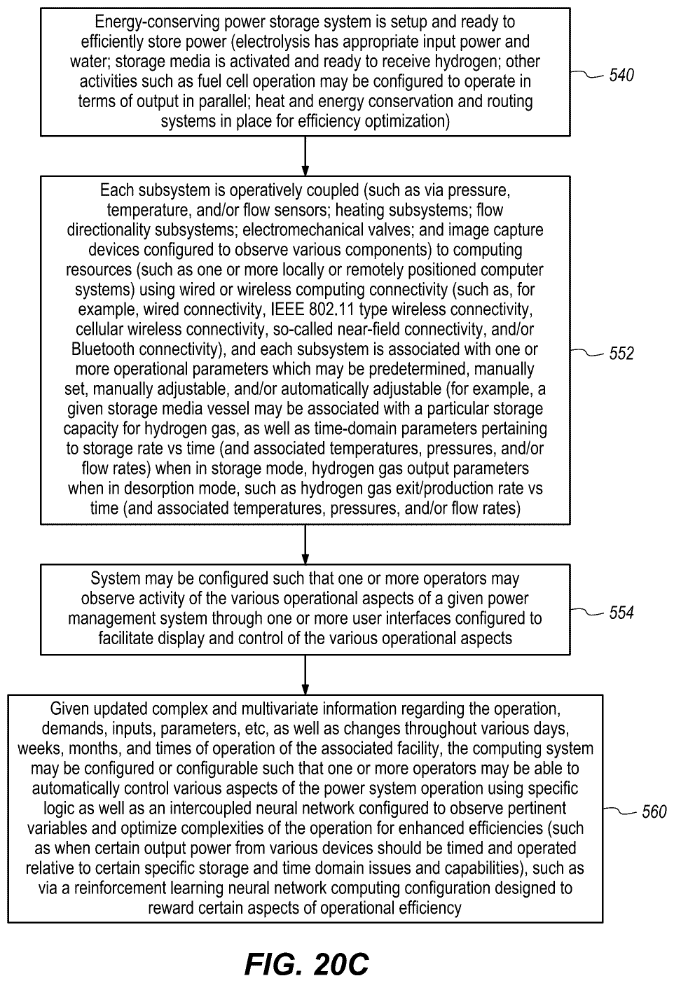

Referring to FIG. 20A, an energy-conserving power storage system may be setup and ready to efficiently store power (electrolysis has appropriate input power and water; storage media is activated and ready to receive hydrogen; other activities such as fuel cell operation may be configured to operate in terms of output in parallel; heat and energy conservation and routing systems in place for efficiency optimization) (540). Each subsystem may be operatively coupled (such as via pressure, temperature, and/or flow sensors; heating subsystems; flow directionality subsystems; electromechanical valves; and image capture devices configured to observe various components) to computing resources (such as one or more locally or remotely positioned computer systems) using wired or wireless computing connectivity (such as, for example, wired connectivity, IEEE 802.11 type wireless connectivity, cellular wireless connectivity, so-called near-field connectivity, and/or Bluetooth connectivity), and each subsystem may be associated with one or more operational parameters which may be predetermined, manually set, manually adjustable, and/or automatically adjustable (for example, a given storage media vessel may be associated with a particular storage capacity for hydrogen gas, as well as time-domain parameters pertaining to storage rate vs time (and associated temperatures, pressures, and/or flow rates) when in storage mode, hydrogen gas output parameters when in desorption mode, such as hydrogen gas exit/production rate vs time (and associated temperatures, pressures, and/or flow rates) (552). The system may be configured such that one or more operators may observe activity of the various operational aspects of a given power management system through one or more user interfaces configured to facilitate display and control of the various operational aspects (554). Given updated information regarding the operation, demands, inputs, parameters, etc, one or more operators may be able to manually control various aspects of the power system operation (such as when certain output power from an operatively coupled roof-mounted wind turbine module is to be channeled to electrolysis to produce and store hydrogen gas during a given day) (556).

Referring to FIG. 20B, an energy-conserving power storage system may be setup and ready to efficiently store power (electrolysis has appropriate input power and water; storage media is activated and ready to receive hydrogen; other activities such as fuel cell operation may be configured to operate in terms of output in parallel; heat and energy conservation and routing systems in place for efficiency optimization) (540). Each subsystem may be operatively coupled (such as via pressure, temperature, and/or flow sensors; heating subsystems; flow directionality subsystems; electromechanical valves; and image capture devices configured to observe various components) to computing resources (such as one or more locally or remotely positioned computer systems) using wired or wireless computing connectivity (such as, for example, wired connectivity, IEEE 802.11 type wireless connectivity, cellular wireless connectivity, so-called near-field connectivity, and/or Bluetooth connectivity), and each subsystem may be associated with one or more operational parameters which may be predetermined, manually set, manually adjustable, and/or automatically adjustable (for example, a given storage media vessel may be associated with a particular storage capacity for hydrogen gas, as well as time-domain parameters pertaining to storage rate vs time (and associated temperatures, pressures, and/or flow rates) when in storage mode, hydrogen gas output parameters when in desorption mode, such as hydrogen gas exit/production rate vs time (and associated temperatures, pressures, and/or flow rates) (552). The system may be configured such that one or more operators may observe activity of the various operational aspects of a given power management system through one or more user interfaces configured to facilitate display and control of the various operational aspects (554). Given updated information regarding the operation, demands, inputs, parameters, etc, the computing system may be configured or configurable such that one or more operators may be able to automatically control various aspects of the power system operation using specific logic (such as when certain output power from an operatively coupled roof-mounted wind turbine module is to be automatically channeled to electrolysis to produce and store hydrogen gas during a given day) (558).

Referring to FIG. 20C, an energy-conserving power storage system may be setup and ready to efficiently store power (electrolysis has appropriate input power and water; storage media is activated and ready to receive hydrogen; other activities such as fuel cell operation may be configured to operate in terms of output in parallel; heat and energy conservation and routing systems in place for efficiency optimization) (540). Each subsystem may be operatively coupled (such as via pressure, temperature, and/or flow sensors; heating subsystems; flow directionality subsystems; electromechanical valves; and image capture devices configured to observe various components) to computing resources (such as one or more locally or remotely positioned computer systems) using wired or wireless computing connectivity (such as, for example, wired connectivity, IEEE 802.11 type wireless connectivity, cellular wireless connectivity, so-called near-field connectivity, and/or Bluetooth connectivity), and each subsystem may be associated with one or more operational parameters which may be predetermined, manually set, manually adjustable, and/or automatically adjustable (for example, a given storage media vessel may be associated with a particular storage capacity for hydrogen gas, as well as time-domain parameters pertaining to storage rate vs time (and associated temperatures, pressures, and/or flow rates) when in storage mode, hydrogen gas output parameters when in desorption mode, such as hydrogen gas exit/production rate vs time (and associated temperatures, pressures, and/or flow rates) (552). The system may be configured such that one or more operators may observe activity of the various operational aspects of a given power management system through one or more user interfaces configured to facilitate display and control of the various operational aspects (554). Given updated complex and multivariate information regarding the operation, demands, inputs, parameters, etc, as well as changes throughout various days, weeks, months, and times of operation of the associated facility, the computing system may be configured or configurable such that one or more operators may be able to automatically control various aspects of the power system operation using specific logic as well as an intercoupled neural network configured to observe pertinent variables and optimize complexities of the operation for enhanced efficiencies (such as when certain output power from various devices should be timed and operated relative to certain specific storage and time domain issues and capabilities), such as via a reinforcement learning neural network computing configuration designed to reward certain aspects of operational efficiency (560).

Referring to FIG. 21A, a configuration similar to that of FIG. 10B is shown, with additional illustration of water input (4), such as for electrolysis (8), and water output (5), such as in the form of distilled water or water vapor, from fuel cell operation (30). FIG. 21B illustrates a simplified form of such a configuration, with inputs from systems such as photovoltaic (288) and electricity plant (282), an activated metal hydride energy system (36) such as those described in further detail above, water output (5), and significant electricity output (3), portions of which may be routed to various destinations. Indeed, referring to FIG. 21C, in a more commercially organized form of presentation, an activated metal hydride energy system (36) is shown in a box type of physical format, with a minimal amount of electricity input (for example, for electrolysis), water input (4), water output (5), and significant electricity output (3) based upon the combination of electrolysis for hydrogen production, storage of hydrogen, desorption of hydrogen from storage such as toward a fuel cell, and fuel cell operation to output electricity. Such a configuration may be implemented in many systems and system integrations.

Referring to FIG. 22, a hybrid vehicle chassis with drive system (584) is shown comprising two electric drive motors (580, 582), a main battery system (578), and an intercoupled computing system (32) which may be also operatively coupled (574) to an activated metal hydride energy system (36) configured to output significant electricity as described above. The output electricity may be controllably routed (576) to the main battery (578), directly (570, 572) to one or both drive motors, or to other components to assist with their operation, and to provide an additional source of power for the vehicle generally.

Referring to FIG. 23A, an assembly (484, 485) of activated metal hydride energy systems (36) may be utilized to assist in supplying a power grid, such as a municipal power grid (586), which may be responsive to various time-domain human use related challenges such as demand peaks in the evening after dark, when photovoltaic-based energy sources, such as an intercoupled solar power system (288) may not be producing electricity at maximum levels as they perhaps were in the middle of the daylight hours. Intercoupled (240, 590, 592, 588) computing (32) and management/control (228) resources may be configured to controllably direct (594, 596) power from these two primary sources (36; 484, 485/288) into the grid (586) in a manner that smoothes out the time-domain issues. For example, in one embodiment, during the middle of the daylight cycle, some power may be directed from photovoltaic (288) toward activated metal hydride energy systems (36; 484, 485) and/or batteries (not shown in FIG. 23A; refer, for example, to element 598 of FIG. 23B), so that during darker hours when photovoltaic (288) may not be as effective, power may be pulled into the grid from the batteries and activated metal hydride energy systems (36; 484, 485).

Similarly, referring to FIG. 23B, a system features operatively coupled (240, 604, 606, 608, 610, 612, 614, 616, 618, 620, 622, 624, 626) computing (32), operations/management (228), conventional power plant (282), activated metal hydride energy systems (36; 484, 485), large scale battery (598), and photovoltaic (288) systems with power consumption systems such as an electric vehicle (602) at a charger (300), a business building or campus (286), and a home (600). The operatively coupled computing resources (32) may be utilized to assist operators (228) and automation configurations in managing the production and routing of power to meet demands through the day or other cycle in an optimal manner, such as by automatically navigating certain time domain factors such as human demand and photovoltaic output vis-à-vis daylight hours.

Referring to FIG. 24A, it may be helpful to pair a particularly energy-consumptive or high-demand system or subsystem (628) with an activated metal hydride energy system (36; 484, 485) to assist with local demand around such high-demand module. FIG. 24A illustrates a configuration wherein computing (32) and management (228) resources may be operatively coupled (630, 632, 240, 634, 636, 638) with various sources of power (such as photovoltaic 288; conventional power plant 282; as well as locally-paired activated metal hydride energy systems 36; 484, 485) for precision input control to meet demands and changes thereto. For example, referring to FIG. 24B, it may be helpful in various configurations to have one or more activated metal hydride energy systems (36; 484, 485) paired with a significant power consumption system (628) such as a computing or so-called “data center” (640). Similarly, referring to FIG. 24C, it may be helpful in various configurations to have one or more activated metal hydride energy systems (36; 484, 485) paired with a significant power consumption system (628) such as a refrigerated warehouse (642). Similarly, referring to FIG. 24D, it may be helpful in various configurations to have one or more activated metal hydride energy systems (36; 484, 485) paired with a significant power consumption system (628) such as a fueling station (644). With such a configuration, activated metal hydride energy systems (36; 484, 485) may also be utilized as a source of hydrogen gas (i.e., hydrogen gas may be pulled out of storage by desorption, as described above, and routed for fuel distribution to, for example, a hydrogen-powered vehicle, rather than a local fuel cell for local power generation) to be distributed at the fueling station (644).

Referring to FIG. 25A, another variation of a hybrid chassis (650) and drivetrain configuration (648) is illustrated with not only an internal combustion engine (644) and one or more electric drive motors (668), but also an activated metal hydride energy system (36) operatively coupled (660, 662, 661, 658, 656) with other components such as a computer system (32), main battery (652), and water supply (654, such as a water tank) such that power for driving and operating the vehicle assembly (648) may be controllably drawn from not only the main battery (652) and intercoupled electric motor (668), but also from the internal combustion engine (644) and activated metal hydride energy system (36), which may, for example, be configured to provide power to charge the main battery (652) and/or assist in providing electricity input for the electric drive motor (668).

Referring to FIG. 25B, systems and elements similar to those shown in FIG. 25A may be utilized in larger scale vehicles, such as electric (or hybrid) tractor-trailer truck (672) configurations, wherein one or more activated metal hydride energy systems (36) may be operatively coupled (674) with drive elements, such as electric drive motors (668).

Referring to FIG. 25C, systems and elements similar to those shown in FIG. 25A may be utilized in additional larger scale vehicles or assemblies thereof, such as train (676) configurations, wherein one or more activated metal hydride energy systems (36) may be operatively coupled (674) with drive elements, such as electric drive motors (668). With a conventional train configuration, an internal combustion engine (664), such as a diesel engine, is utilized to power a large generator or alternator that is operatively coupled to one or more large electric drive motors (668) within the so-called “engine” vehicle (678; as opposed to the mechanically coupled connected cargo vehicles 680, 681). With a configuration such as that depicted, a relatively large scale activated metal hydride energy system (36) may be coupled to the train assembly (676), such as via coupling to a discrete power generation vehicle or car (682), with the activated metal hydride energy system (36) operatively coupled (674) to provide electricity to the drive motor (668), for example, as shown.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Any of the devices described for carrying out the subject diagnostic or interventional procedures may be provided in packaged combination for use in executing such interventions. These supply “kits” may further include instructions for use and be packaged in sterile trays or containers as commonly employed for such purposes.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. An integrated energy storage and distribution system, comprising:
a. an electrolysis module configured to utilize intake electricity and intake water to output hydrogen gas, oxygen, and surplus water;
b. a metal hydride hydrogen storage module configured to controllably store, or alternatively release, hydrogen gas;
c. a fuel cell module configured to controllably intake hydrogen gas and output electricity and water vapor; and
d. a computing system operatively coupled to the electrolysis module, storage module, and fuel cell module and configured to coordinate operation of these modules relative to each other;
wherein the electrolysis, storage, and fuel cell modules are thermally coupled such that heat energy released from one or more modules which may be at least transiently exothermic may be utilized by one or modules which may be at least transiently endothermic.

2. The system of claim 1, wherein the electrolysis module comprises a proton exchange membrane electrolysis system comprising an electrolyte configured to conduct protons, separate one or more gases which may be produced, and electrically isolate an anode from a cathode.

3. The system of claim 1, wherein the electrolysis module is configured to heat the intake water to enhance reactivity and a rate of production of the hydrogen gas.

4. The system of claim 1, wherein a temperature of the surplus water from the electrolysis module becomes elevated relative to a temperature of the intake water.

5. The system of claim 1, further comprising an output sensor operatively coupled to the electrolysis module and configured to measure one or more factors correlated with the output of hydrogen gas.

6. The system of claim 5, wherein the output sensor comprises a pressure sensor.

7. The system of claim 5, wherein the output sensor comprises a flow meter.

8. The system of claim 5, wherein the output sensor is operatively coupled to the computing system.

9. The system of claim 1, further comprising a temperature sensor operatively coupled to the electrolysis module and configured to measure a temperature correlated with operation of the electrolysis module.

10. The system of claim 9, wherein the temperature sensor is selected from the group consisting of: a thermometer, a thermocouple, and an infrared detector.

11. The system of claim 1, wherein storage module comprises a metallic storage vessel configured to securely and removably contain a predetermined portion of metal hydride material.

12. The system of claim 11, wherein the metallic storage vessel comprises 316L stainless steel.

13. The system of claim 11, wherein the metallic storage vessel comprises a substantially cylindrical body portion.

14. The system of claim 13, wherein the metallic storage vessel comprises one or more substantially circular end portions removably coupled to the substantially cylindrical body portion.

15. The system of claim 14, wherein the one or more substantially circular end portions are removably coupled to the substantially cylindrical body portion by a plurality of removable fastener components.

16. The system of claim 15, wherein the plurality of removable fastener components comprise a plurality of high-strength bolts and nuts.

17. The system of claim 13, wherein the metallic storage vessel comprises one or more substantially circular end portions coupled to the substantially cylindrical body portion using a metallic welded interface.

18. The system of claim 11, wherein the metallic storage vessel comprises an input/output interface configured to allow controlled entrance and exit of hydrogen gas from the metallic storage vessel.

19. The system of claim 11, wherein the metallic storage vessel comprises a thermal energy transfer module configured to controllably add or remove heat from the metallic storage vessel.

20. The system of claim 19, wherein the thermal energy transfer module comprises a flow circuit configured to facilitate controllable flow of a thermal transfer fluid.

21. The system of claim 20, wherein the flow circuit is configured to enter and exit an interior volume defined by the metallic storage vessel to contain the metal hydride material.

22. The system of claim 21, wherein the flow circuit is configured to enter and exit the interior volume through a plurality of apertures defined through a portion of the metallic storage vessel.

23. The system of claim 22, wherein the interior volume is defined by a body portion and one or more end portions coupled to the body portion, and wherein the plurality of apertures are defined through an end portion coupled to a body portion.

24. The system of claim 20, wherein the flow circuit comprises a tubing assembly defining a flow pathway therethrough.

25. The system of claim 24, wherein the tubing assembly comprises an at least partially helical shape.

26. The system of claim 24, wherein the tubing assembly comprises an assembly of substantially straight elongate tubing portions coupled by shorter arcuate tubing portions.

27. The system of claim 24, wherein the flow pathway comprises a unitary pathway of flow defined through the tubing assembly.

28. The system of claim 24, wherein the flow pathway comprises a plural pathway of flow defined through the tubing assembly such that flow is directed through a plurality of two or more parallel branches of the tubing assembly.

29. The system of claim 24, wherein the tubing assembly is coupled to one or more surface expansion structures configured to increase thermal conduction between the tubing assembly and portions of the metal hydride material which may be positioned adjacent the tubing assembly.

30. The system of claim 19, wherein the thermal energy transfer module comprises a resistive heating element.

31. The system of claim 30, wherein the resistive heating element is coupled across at least a portion of the metallic storage vessel such that a portion of the resistive heating element is positioned in an indwelling manner within a portion of an interior volume defined by the metallic storage vessel to contain the metal hydride material.

32. The system of claim 30, wherein the resistive heating element is coupled to at least one external aspect of the metallic storage vessel to provide controlled resistive heating directly thereto.

33. The system of claim 30, wherein the resistive heating element comprises an at least partially helical shape.

34. The system of claim 30, wherein the resistive heating element comprises a discrete element configured to be in contact with an external portion of the metallic storage vessel.

35. The system of claim 34, wherein the resistive heating element comprises a perimetric heating cuff element.

36. The system of claim 35, wherein the perimetric heating cuff element comprises a patterned heating element.

37. The system of claim 35, wherein the perimetric heating cuff element comprises a matrix heating element.

38. The system of claim 11, wherein the metal hydride material is an AB2 classified metal hydride.

39. The system of claim 38, wherein the AB2 classified metal hydride comprises titanium.

40. The system of claim 39, wherein the titanium metal hydride comprises hydralloy C5 with a stoichiometry configuration of about Ti 0.95 Zr 0.05 Mn 1.46 V 0.45 Fe 0.09.

41. The system of claim 40, wherein the hydralloy C5 within the metallic storage vessel has been activated for hydrogen storage and release using an activation pressurization with hydrogen gas of about 60 bars.

42. The system of claim 41, wherein the hydralloy C5 within the metallic storage vessel has been activated for hydrogen storage and release using an activation pressurization with hydrogen gas of about 60 bars in situ within the particular metallic storage vessel.

43. The system of claim 11, wherein the metal hydride material is an AB classified metal hydride.

44. The system of claim 43, wherein the AB classified metal hydride comprises titanium.

45. The system of claim 44, wherein the titanium metal hydride comprises ferrotitanium (FeTi).

46. The system of claim 45, wherein the ferrotitanium within the metallic storage vessel has been activated for hydrogen storage and release using an activation pressurization with hydrogen gas of about 60 bars and an activation temperature of about 400 degrees C.

47. The system of claim 46, wherein the ferrotitanium within the metallic storage vessel has been activated for hydrogen storage and release using an activation pressurization with hydrogen gas of about 60 bars and an activation temperature of about 400 degrees C. in situ within the particular metallic storage vessel.

48. The system of claim 1, further comprising a sensor operatively coupled to the metallic storage vessel and computing system, the sensor configured to provide information pertaining to the operation of the metallic storage vessel.

49. The system of claim 48, wherein the sensor comprises a pressure sensor.

50. The system of claim 48, wherein the sensor comprises a temperature sensor.

51. The system of claim 50, wherein the temperature sensor is selected from the group consisting of: a thermometer, a thermocouple, and an infrared detector.

52. The system of claim 48, wherein the sensor comprises a flow meter.

53. The system of claim 48, wherein at least a portion of the sensor is coupled across at least a portion of the metallic storage vessel such that the portion of the sensor is positioned in an indwelling manner within a portion of an interior volume defined by the metallic storage vessel to contain the metal hydride material.

54. The system of claim 1, wherein the fuel cell module comprises a proton exchange membrane fuel cell stack.

55. The system of claim 1, further comprising a sensor operatively coupled to the fuel cell module and computing system, the sensor configured to provide information pertaining to the operation of the fuel cell module.

56. The system of claim 55, wherein the sensor is selected from a group consisting of: a temperature sensor, a current sensor, and a pressure sensor.

57. The system of claim 56, wherein the sensor is a temperature sensor selected from the group consisting of: a thermometer, a thermocouple, and an infrared detector.

58. The system of claim 55, wherein the computing system is configured to coordinate operation of the electrolysis module, storage module, and fuel cell module in a closed loop control configuration such that hydrogen gas is stored and/or released from the storage module dynamic at least in part to demands for electricity made upon the fuel cell module.

59. The system of claim 11, wherein the storage module comprises a plurality of metallic storage vessels coupled together in a common rack structure, each of which is operatively coupled to the computing system, fuel cell module, and electrolysis module.

60. A metal hydride hydrogen storage module operatively coupled to a computing system and configured to controllably store, or alternatively release, hydrogen gas based at least in part upon commands from the computing system.

61. The system of claim 60, wherein storage module comprises a metallic storage vessel configured to securely and removably contain a predetermined portion of metal hydride material.

62. The system of claim 61, wherein the metallic storage vessel comprises 316L stainless steel.

63. The system of claim 61, wherein the metallic storage vessel comprises a substantially cylindrical body portion.

64. The system of claim 63, wherein the metallic storage vessel comprises one or more substantially circular end portions removably coupled to the substantially cylindrical body portion.

65. The system of claim 64, wherein the one or more substantially circular end portions are removably coupled to the substantially cylindrical body portion by a plurality of removable fastener components.

66. The system of claim 65, wherein the plurality of removable fastener components comprise a plurality of high-strength bolts and nuts.

67. The system of claim 63, wherein the metallic storage vessel comprises one or more substantially circular end portions coupled to the substantially cylindrical body portion using a metallic welded interface.

68. The system of claim 61, wherein the metallic storage vessel comprises an input/output interface configured to allow controlled entrance and exit of hydrogen gas from the metallic storage vessel.

69. The system of claim 61, wherein the metallic storage vessel comprises a thermal energy transfer module configured to controllably add or remove heat from the metallic storage vessel.

70. The system of claim 69, wherein the thermal energy transfer module comprises a flow circuit configured to facilitate controllable flow of a thermal transfer fluid.

71. The system of claim 70, wherein the flow circuit is configured to enter and exit an interior volume defined by the metallic storage vessel to contain the metal hydride material.

72. The system of claim 71, wherein the flow circuit is configured to enter and exit the interior volume through a plurality of apertures defined through a portion of the metallic storage vessel.

73. The system of claim 72, wherein the interior volume is defined by a body portion and one or more end portions coupled to the body portion, and wherein the plurality of apertures are defined through an end portion coupled to a body portion.

74. The system of claim 70, wherein the flow circuit comprises a tubing assembly defining a flow pathway therethrough.

75. The system of claim 74, wherein the tubing assembly comprises an at least partially helical shape.

76. The system of claim 74, wherein the tubing assembly comprises an assembly of substantially straight elongate tubing portions coupled by shorter arcuate tubing portions.

77. The system of claim 74, wherein the flow pathway comprises a unitary pathway of flow defined through the tubing assembly.

78. The system of claim 74, wherein the flow pathway comprises a plural pathway of flow defined through the tubing assembly such that flow is directed through a plurality of two or more parallel branches of the tubing assembly.

79. The system of claim 74, wherein the tubing assembly is coupled to one or more surface expansion structures configured to increase thermal conduction between the tubing assembly and portions of the metal hydride material which may be positioned adjacent the tubing assembly.

80. The system of claim 69, wherein the thermal energy transfer module comprises a resistive heating element.

81. The system of claim 80, wherein the resistive heating element is coupled across at least a portion of the metallic storage vessel such that a portion of the resistive heating element is positioned in an indwelling manner within a portion of an interior volume defined by the metallic storage vessel to contain the metal hydride material.

82. The system of claim 80, wherein the resistive heating element is coupled to at least one external aspect of the metallic storage vessel to provide controlled resistive heating directly thereto.

83. The system of claim 80, wherein the resistive heating element comprises an at least partially helical shape.

84. The system of claim 80, wherein the resistive heating element comprises a discrete element configured to be in contact with an external portion of the metallic storage vessel.

85. The system of claim 84, wherein the resistive heating element comprises a perimetric heating cuff element.

86. The system of claim 85, wherein the perimetric heating cuff element comprises a patterned heating element.

87. The system of claim 85, wherein the perimetric heating cuff element comprises a matrix heating element.

88. The system of claim 61, wherein the metal hydride material is an AB2 classified metal hydride.

89. The system of claim 88, wherein the AB2 classified metal hydride comprises titanium.

90. The system of claim 89, wherein the titanium metal hydride comprises hydralloy C5 with a stoichiometry configuration of about Ti 0.95 Zr 0.05 Mn 1.46 V 0.45 Fe 0.09.

91. The system of claim 90, wherein the hydralloy C5 within the metallic storage vessel has been activated for hydrogen storage and release using an activation pressurization with hydrogen gas of about 60 bars.

92. The system of claim 91, wherein the hydralloy C5 within the metallic storage vessel has been activated for hydrogen storage and release using an activation pressurization with hydrogen gas of about 60 bars in situ within the particular metallic storage vessel.

93. The system of claim 61, wherein the metal hydride material is an AB classified metal hydride.

94. The system of claim 93, wherein the AB classified metal hydride comprises titanium.

95. The system of claim 94, wherein the titanium metal hydride comprises ferrotitanium (FeTi).

96. The system of claim 95, wherein the ferrotitanium within the metallic storage vessel has been activated for hydrogen storage and release using an activation pressurization with hydrogen gas of about 60 bars and an activation temperature of about 400 degrees C.

97. The system of claim 96, wherein the ferrotitanium within the metallic storage vessel has been activated for hydrogen storage and release using an activation pressurization with hydrogen gas of about 60 bars and an activation temperature of about 400 degrees C. in situ within the particular metallic storage vessel.

98. The system of claim 60, further comprising a sensor operatively coupled to the metallic storage vessel and computing system, the sensor configured to provide information pertaining to the operation of the metallic storage vessel.

99. The system of claim 98, wherein the sensor comprises a pressure sensor.

100. The system of claim 98, wherein the sensor comprises a temperature sensor.

101. The system of claim 100, wherein the temperature sensor is selected from the group consisting of: a thermometer, a thermocouple, and an infrared detector.

102. The system of claim 98, wherein the sensor comprises a flow meter.

103. The system of claim 98, wherein at least a portion of the sensor is coupled across at least a portion of the metallic storage vessel such that the portion of the sensor is positioned in an indwelling manner within a portion of an interior volume defined by the metallic storage vessel to contain the metal hydride material.

104-420. (canceled)
